(19) United States
(12) Patent Application Publication
(10) Pub. No.: US 2021/0149164 A1
(43) Pub. Date: May 20, 2021

(54) Optical Imaging Lens Group

(71) Applicant: ZHEJIANG SUNNY OPTICS CO.,LTD., Ningbo, Zhejiang (CN)

(72) Inventors: Tao FENG, Ningbo, Zhejiang (CN); Yabin HU, Ningbo, Zhejiang (CN)

(21) Appl. No.: 17/258,755

(22) PCT Filed: May 5, 2019
(86) PCT No.: PCT/CN2019/085514

§ 371 Date: Jan. 8, 2021

(30) Foreign Application Priority Data
Aug. 6, 2018 (CN) 201810886764.3

(51) Int. Cl. G02B 13/00; G02B 9/64; G02B 27/00

(52) U.S. Cl. CPC G02B 13/0045; G02B 27/0025; G02B 9/64

(57) ABSTRACT

An optical imaging lens group sequentially includes, from an object side to an image side along an optical axis, a first lens (E1), a second lens (E2), a third lens (E3), a fourth lens (E4), a fifth lens (E5), a sixth lens (E6), a seventh lens (E7) and an eighth lens (E8). The first lens has positive refractive power, and both an object-side surface and an image-side surface thereof are convex surfaces. The second lens has refractive power, and an object-side surface thereof is a concave surface. The third lens has refractive power. The fourth lens has negative refractive power. The fifth lens has positive refractive power. The sixth lens has refractive power. The seventh lens has refractive power, and an object-side surface thereof is a concave surface. The eighth lens has negative refractive power.

### CROSS-REFERENCE TO RELATED APPLICATIONS

The disclosure claims priority to Chinese Patent Application No. 201810886764.3, filed to the National Intellectual Property Administration, PRC (CNIPA) on Aug. 6, 2018, the disclosure of which is hereby incorporated by reference in its entirety.

### TECHNICAL FIELD

The disclosure relates to an optical imaging lens group, and more particularly to an optical imaging lens group including eight lenses.

### BACKGROUND

In recent years, along with the rapid upgrading of portable electronic products such as mobile phones and tablet computers, market requirements on imaging lenses of products have been increasingly diversified. At the present stage, an imaging lens is required to have the characteristic of small size for better application to a portable electronic product, and is also required to have the characteristics of high pixel, high resolution, great focal length and the like to meet imaging requirements of each field.

Particularly, a dual-lens concept presently proposed in a photographic function requires combination of two to three optical imaging lenses and a chip image processing algorithm to implement 3× to 5× optical zooming. A telephoto lens in these imaging lenses is required to have the characteristics of high magnification factor, small depth of field and the like to help to implement image background blurring and achieve a better shooting effect.

### SUMMARY

Some embodiments of the disclosure provides an optical imaging lens group, for example, an optical imaging lens group usable as a telephoto lens in a dual-lens camera, applied to a portable electronic product and capable of at least overcoming or partially overcoming at least one shortcoming in a conventional art.

According to an aspect, the disclosure provides an optical imaging lens group, which sequentially includes, from an object side to an image side along an optical axis, a first lens, a second lens, a third lens, a fourth lens, a fifth lens, a sixth lens, a seventh lens and an eighth lens, wherein the first lens may have positive refractive power, and both an object-side surface and an image-side surface thereof may be convex surfaces; the second lens may have refractive power, and an object-side surface thereof may be a concave surface; the third lens may have refractive power; the fourth lens may have negative refractive power; the fifth lens may have positive refractive power; the sixth lens has refractive power; the seventh lens has refractive power, and an object-side surface thereof may be a concave surface; and the eighth lens may have negative refractive power.

In an implementation mode, a maximum half-field of view (HFOV) of the optical imaging lens group may meet HFOV30°.

In an implementation mode, a total effective focal length f of the optical imaging lens group and an effective focal length f1 of the first lens may meet 0.3<f1/f<1.2.

In an implementation mode, a maximum effective semi-diameter DT11 of the object-side surface of the first lens and a maximum effective semi-diameter DT41 of an object-side surface of the fourth lens may meet 1<DT11/DT41<2.5.

In an implementation mode, a distance SAG42 from an intersection point of an image-side surface of the fourth lens to the optical axis to a vertex of an effective semi-diameter of the image-side surface of the fourth lens and a distance SAG71 from an intersection point of the object-side surface of the seventh lens and the optical axis to a vertex of an effective semi-diameter of the object-side surface of the seventh lens may meet |SAG42/SAG71|<0.7.

In an implementation mode, an effective focal length f4 of the fourth lens and an effective focal length f5 of the fifth lens may meet −1.5<f4/f5<−0.3.

In an implementation mode, a curvature radius R13 of the object-side surface of the seventh lens and a curvature radius R1 of the object-side surface of the first lens may meet −2.5<R13/R1<−0.5.

In an implementation mode, a center thickness CT1 of the first lens on the optical axis, a center thickness CT2 of the second lens on the optical axis and a center thickness CT3 of the third lens on the optical axis may meet 0.5<CT1/(CT2+CT3)<2.5.

In an implementation mode, a center thickness CT5 of the fifth lens on the optical axis, a center thickness CT6 of the sixth lens on the optical axis and a center thickness CT7 of the seventh lens on the optical axis may meet 0.9<CT5/(CT6+CT7)<2.

In an implementation mode, a combined focal length f67 of the sixth lens and the seventh lens and a combined focal length f123 of the first lens, the second lens and the third lens may meet −3≤f67/f123<−1.

In an implementation mode, a sum EAT of spacing distances of any two adjacent lenses in the first lens to the eighth lens on the optical axis and a distance TTL from the object-side surface of the first lens to an imaging surface of the optical imaging lens group on the optical axis may meet 0.2<ΣAT/TTL<0.5.

According to another aspect, the disclosure also provides an optical imaging lens group, which sequentially includes, from an object side to an image side along an optical axis, a first lens, a second lens, a third lens, a fourth lens, a fifth lens, a sixth lens, a seventh lens and an eighth lens, wherein the first lens may have positive refractive power, and both an object-side surface and an image-side surface thereof may be convex surfaces; the second lens may have refractive power, and an object-side surface thereof may be a concave surface; the third lens may have refractive power; the fourth lens may have negative refractive power; the fifth lens may have positive refractive power; the sixth lens has refractive power; the seventh lens has refractive power; the eighth lens may have negative refractive power; and a maximum half-field of view (HFOV) of the optical imaging lens group may meet HFOV≤30°.

According to the disclosure, eight lenses are adopted, and refractive power of each lens, a surface type, a center thickness of each lens, on-axis distances between the lenses and the like are reasonably configured to achieve at least one beneficial effect of great focal length, high imaging quality, small size and the like of the optical imaging lens group.

### BRIEF DESCRIPTION OF THE DRAWINGS

Detailed descriptions are made to unrestrictive implementation modes below in combination with the drawings to make the other characteristics, purposes and advantages of the disclosure more apparent. In the drawings:

FIG. 1 shows a structure diagram of an optical imaging lens group according to embodiment 1 of the disclosure; FIG. 2A to FIG. 2D show a longitudinal aberration curve, astigmatism curve, distortion curve and lateral color curve of an optical imaging lens group according to embodiment 1 respectively;

FIG. 3 shows a structure diagram of an optical imaging lens group according to embodiment 2 of the disclosure; FIG. 4A to FIG. 4D show a longitudinal aberration curve, astigmatism curve, distortion curve and lateral color curve of an optical imaging lens group according to embodiment 2 respectively;

FIG. 5 shows a structure diagram of an optical imaging lens group according to embodiment 3 of the disclosure; FIG. 6A to FIG. 6D show a longitudinal aberration curve, astigmatism curve, distortion curve and lateral color curve of an optical imaging lens group according to embodiment 3 respectively;

FIG. 7 shows a structure diagram of an optical imaging lens group according to embodiment 4 of the disclosure; FIG. 8A to FIG. 8D show a longitudinal aberration curve, astigmatism curve, distortion curve and lateral color curve of an optical imaging lens group according to embodiment 4 respectively;

FIG. 9 shows a structure diagram of an optical imaging lens group according to embodiment 5 of the disclosure; FIG. 10A to FIG. 10D show a longitudinal aberration curve, astigmatism curve, distortion curve and lateral color curve of an optical imaging lens group according to embodiment 5 respectively;

FIG. 11 shows a structure diagram of an optical imaging lens group according to embodiment 6 of the disclosure; FIG. 12A to FIG. 12D show a longitudinal aberration curve, astigmatism curve, distortion curve and lateral color curve of an optical imaging lens group according to embodiment 6 respectively;

FIG. 13 shows a structure diagram of an optical imaging lens group according to embodiment 7 of the disclosure; FIG. 14A to FIG. 14D show a longitudinal aberration curve, astigmatism curve, distortion curve and lateral color curve of an optical imaging lens group according to embodiment 7 respectively;

FIG. 15 shows a structure diagram of an optical imaging lens group according to embodiment 8 of the disclosure; FIG. 16A to FIG. 16D show a longitudinal aberration curve, astigmatism curve, distortion curve and lateral color curve of an optical imaging lens group according to embodiment 8 respectively;

FIG. 17 shows a structure diagram of an optical imaging lens group according to embodiment 9 of the disclosure; FIG. 18A to FIG. 18D show a longitudinal aberration curve, astigmatism curve, distortion curve and lateral color curve of an optical imaging lens group according to embodiment 9 respectively;

FIG. 19 shows a structure diagram of an optical imaging lens group according to embodiment 10 of the disclosure; and FIG. 20A to FIG. 20D show a longitudinal aberration curve, astigmatism curve, distortion curve and lateral color curve of an optical imaging lens group according to embodiment 10 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It is to be noted that, in the specification, expressions like first, second and third are adopted not to represent any limit to characteristics but only to distinguish one characteristic from another characteristic. Therefore, a first lens discussed below may also be called a second lens or a third lens under the condition of not departing from the teachings of the disclosure.

For convenient description, thicknesses, sizes and shapes of lenses are slightly magnified in the drawings. Specifically, spherical or aspherical shapes in the drawings are shown exemplarily. That is, spherical or aspherical shapes are not limited to the spherical or aspherical shapes shown in the drawings. The drawings are drawn only exemplarily but not strictly to scale.

In the disclosure, a paraxial region refers to a region nearby an optical axis. If a surface of a lens is a convex surface and a position of the convex surface is not defined, it is indicated that at least a paraxial region of the surface of the lens is a convex surface; and if a surface of a lens is a concave surface and a position of the concave surface is not defined, it is indicated that at least a paraxial region of the surface of the lens is a concave surface. A surface, close to an object side, of each lens is called an object-side surface of the lens, and a surface, close to an image side, of each lens is called an image-side surface of the lens.

It is also to be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail. The characteristics, principles and other aspects of the disclosure will be described below in detail.

An optical imaging lens group according to an exemplary implementation mode of the disclosure may include, for example, eight lenses with refractive power, i.e., a first lens, a second lens, a third lens, a fourth lens, a fifth lens, a sixth lens, a seventh lens and an eighth lens. The eight lenses are sequentially arranged from an object side to an image side along an optical axis, and there may be air spaces between adjacent lenses.

In the exemplary implementation mode, the first lens may have positive refractive power, and both an object-side surface and an image-side surface thereof may be convex surfaces; the second lens may have refractive power, and an object-side surface thereof is a concave surface; the third lens may have refractive power; the fourth lens may have negative refractive power; the fifth lens may have positive refractive power; the sixth lens has refractive power; the seventh lens has refractive power, and an object-side surface thereof may be a concave surface; and the eighth lens may have negative refractive power. The first lens has positive refractive power, which is favorable for correcting astigmatism in a meridian direction. The eighth lens has negative refractive power, which is favorable for correcting a Petzval field curvature and may simultaneously disperse light to achieve the characteristic of great focal length of a system. The image-side surface of the first lens is set to be a convex surface, and the object-side surface of the second lens is set to be a concave surface, so that a color may be effectively corrected. The refractive power of the fourth lens and the fifth lens and a surface type of the seventh lens may be reasonably controlled to effectively balance a low-order aberration of the system and further achieve high imaging quality of the imaging lens group.

In the exemplary implementation mode, the optical imaging lens group of the disclosure may meet a conditional expression HFOV≤30°, where HFOV is a maximum half-field of view of the optical imaging lens group. More specifically, HFOV may further meet 22°≤HFOV≤28°, for example, 23.3°≤HFOV≤25.2°. A full field of view of the imaging lens group may be controlled to be not larger than 60° to ensure a relatively great total effective focal length of the optical imaging lens group and further ensure a relatively high magnification factor and a relatively small depth of field under the condition that a sensor has a specific image surface size.

In the exemplary implementation mode, the optical imaging lens group of the disclosure may meet a conditional expression 1<DT11/DT41<2.5, where DT11 is a maximum effective semi-diameter of the image-side surface of the first lens, and DT41 is a maximum effective semi-diameter of an object-side surface of the fourth lens. More specifically, DT11 and DT41 may further meet 1.22≤DT11/DT41≤2.33. The maximum effective semi-diameter of the object-side surface of the first lens and the maximum effective semi-diameter of the object-side surface of the fourth lens may be reasonably restricted to shield light in an inner field of view and reduce an off-axis comatic aberration by reducing the aperture on one hand and to appropriately shield light in an outer field of view to ensure field of that relative illuminance of the lens group is in a reasonable range on the other hand.

In the exemplary implementation mode, the optical imaging lens group of the disclosure may meet a conditional expression |SAG42/SAG71|<0.7, where SAG42 is a distance from an intersection point of an image-side surface of the fourth lens to the optical axis to a vertex of an effective semi-diameter of the image-side surface of the fourth lens, and SAG71 is a distance from an intersection point of an object-side surface of the seventh lens and the optical axis to a vertex of an effective semi-diameter of the object-side surface of the seventh lens. More specifically, SAG42 and SAG71 may further meet 0.05≤|SAG42/SAG71|≤0.61. Reasonably controlling SAG42 and SAG71 is favorable for ensuring a forming process of the lens and may also effectively reduce a risk in formation of a ghost image.

In the exemplary implementation mode, the optical imaging lens group of the disclosure may meet a conditional expression 0.3<f1/f<1.2, where f is a total effective focal length of the optical imaging lens group, and f1 is an effective focal length of the first lens. More specifically, f1 and f may further meet 0.41≤f1/f≤1.14. Reasonably controlling the refractive power of the first lens to be relatively high positive refractive power may endow the optical imaging lens group with a relatively high field curvature balancing capability.

In the exemplary implementation mode, the optical imaging lens group of the disclosure may meet a conditional expression −1.5<f4/f5<−0.3, where f4 is an effective focal length of the fourth lens, and f5 is an effective focal length of the fifth lens. More specifically, f4 and f5 may further meet −1.47≤f4/f5≤−0.38. Reasonably configuring positive and negative refractive power for the fourth lens and the fifth lens respectively is favorable for balancing the color generated by the system.

In the exemplary implementation mode, the optical imaging lens group of the disclosure may meet a conditional expression −3≤f67/f123<−1, where f67 is a combined focal length of the sixth lens and the seventh lens, and f123 is a combined focal length of the first lens, the second lens and the third lens. More specifically, f67 and f123 may further meet −3.00≤f67/f123≤−1.02. The first lens, second lens and third lens that have positive refractive power as a whole may converge incident beams on the object side, and the sixth lens and seventh lens that have negative refractive power as a whole may disperse light beams to a certain extent, so that correction of a high-order spherical aberration and the off-axis comatic aberration is facilitated.

In the exemplary implementation mode, the optical imaging lens group of the disclosure may meet a conditional expression 0.5<CT1/(CT2+CT3)<2.5, wherein CT1 is a center thickness of the first lens on the optical axis, CT2 is a center thickness of the second lens on the optical axis, and CT3 is a center thickness of the third lens on the optical axis. More specifically, CT1, CT2 and CT3 may further meet 0.71≤CT1/(CT2+CT3)≤2.42. The center thicknesses of the first lens, the second lens and the third lens may be reasonably configured to ensure a relatively small optical total length of the optical imaging lens group.

In the exemplary implementation mode, the optical imaging lens group of the disclosure may meet a conditional expression −2.5<R13/R1<−0.5, where R13 is a curvature radius of the object-side surface of the seventh lens, and R1 is a curvature radius of the object-side surface of the first lens. More specifically, R13 and R1 may further meet −2.28≤R13/R1≤−0.80. Ranges of the curvature radii of the object-side surface of the seventh lens and the object-side surface of the first lens may be reasonably controlled to ensure that positions of ghost images generated by even-order reflection of the two mirror surfaces move out of an effective imaging surface, so that the risk in formation of a ghost image may be effectively reduced.

In the exemplary implementation mode, the optical imaging lens group of the disclosure may meet a conditional expression 0.9<CT5/(CT6+CT7)<2, wherein CT5 is a center thickness of the fifth lens on the optical axis, CT6 is a center thickness of the sixth lens on the optical axis, and CT7 is a center thickness of the seventh lens on the optical axis. More specifically, CT5, CT6 and CT7 may further meet 0.93≤CT5/(CT6+CT7)≤0.89. Controlling the center thicknesses of the fifth lens, the sixth lens and the seventh lens to regulate a distribution of refractive power is favorable for ensure that incident light may be converged on the imaging surface of the optical imaging lens group after passing through each lens.

In the exemplary implementation mode, the optical imaging lens group of the disclosure may meet a conditional expression 0.2<ΣAT/TTL<0.5, where ΣAT is a sum of spacing distances of any two adjacent lenses in the first lens to the eighth lens on the optical axis, and TTL is a distance from the object-side surface of the first lens to an imaging surface of the optical imaging lens group on the optical axis. More specifically, ΣAT and TTL may further meet 0.25≤ΣAT/TTL≤0.40. The conditional expression 0.2<ΣAT/TTL<0.5 is met, so that the size of the optical imaging lens group may be reduced to avoid the condition that the optical imaging lens group is oversized; and meanwhile, difficulties in assembling of the lenses may be reduced, and a relatively high space utilization rate may be achieved.

In the exemplary implementation mode, the optical imaging lens group may further include a diaphragm to improve the imaging quality of the camera lens. Optionally, the diaphragm may be arranged between the third lens and the fourth lens. Optionally, the optical imaging lens group may further include an optical filter configured to correct the color and/or protective glass configured to protect a photosensitive element on the imaging surface.

The optical imaging lens group according to the implementation mode of the disclosure may adopt multiple lenses, for example, the abovementioned eight lenses. The refractive power of each lens, a surface type, a center thickness of each lens, on-axis distances between the lenses and the like are reasonably configured to effectively reduce the size of the camera lens, reduce sensitivity of the camera lens, improve manufacturability of the camera lens and ensure that the optical imaging lens group is more favorable for production and machining and may be applied to a portable electronic product. Meanwhile, the optical imaging lens group configured as above may further have the beneficial effects of great focal length, high imaging quality, small size and the like. The abovementioned optical imaging lens group may be applied to a dual-lens technology as a telephoto lens well.

In the implementation mode of the disclosure, at least one of mirror surfaces of the lenses is an aspherical mirror surface. An aspherical lens has a characteristic that a curvature keeps changing from a center of the lens to a periphery of the lens. Unlike a spherical lens with a constant curvature from a center of the lens to a periphery of the lens, an aspherical lens has a better curvature radius characteristic and the advantages of improving distortions and improving astigmatic aberrations. With adoption of the aspherical lens, the astigmatic aberrations during imaging may be eliminated as much as possible, thereby improving the imaging quality.

However, those skilled in the art should know that the number of the lenses forming the optical imaging lens group may be changed without departing from the technical solutions claimed in the disclosure to achieve each result and advantage described in the specification. For example, although descriptions are made in the implementation with eight lenses as an example, the optical imaging lens group is not limited to include eight lenses. If necessary, the optical imaging lens group may further include another number of lenses. Specific embodiments of the optical imaging lens group applied to the abovementioned implementation mode will further be described below with reference to the drawings.

### Embodiment 1

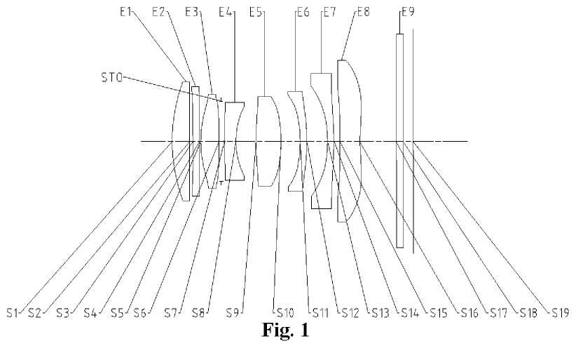

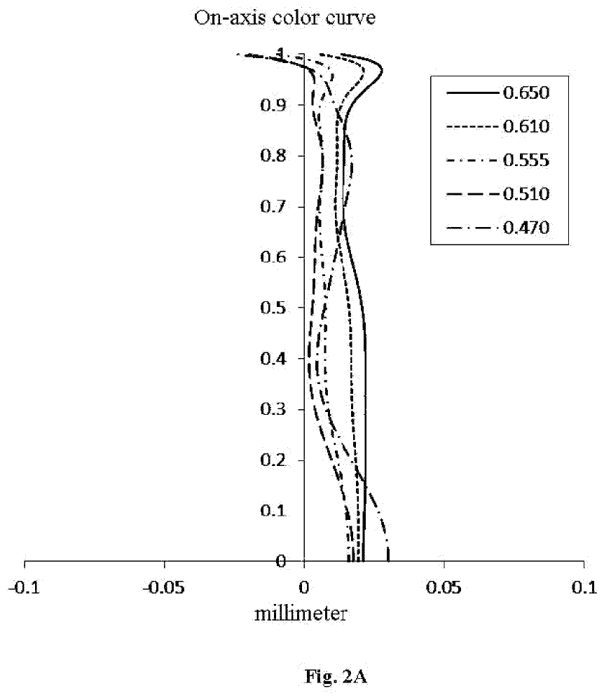

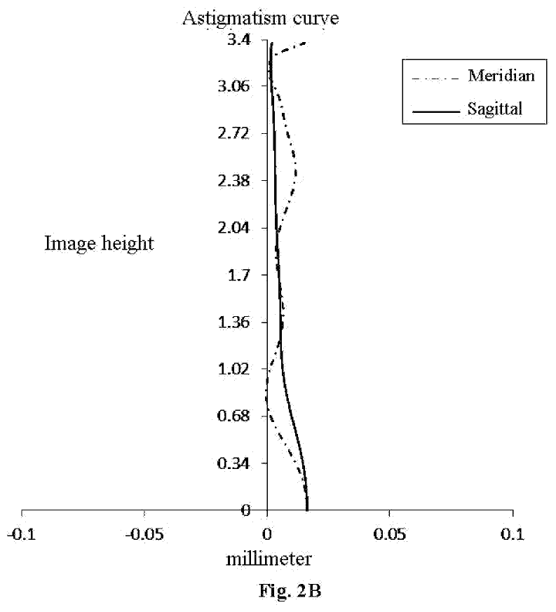

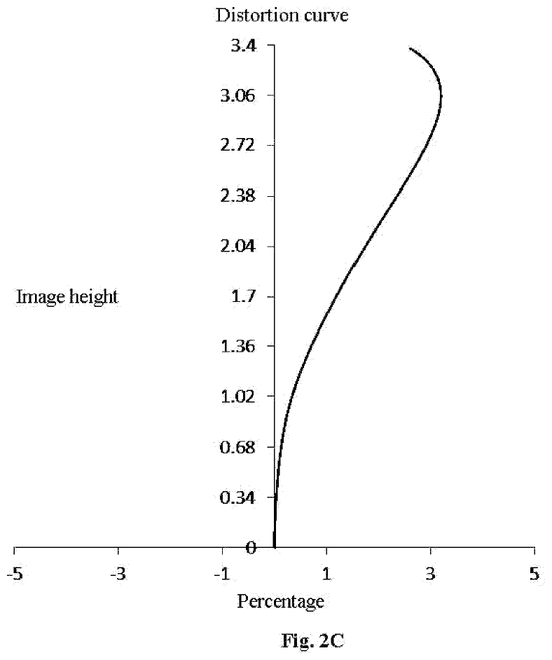

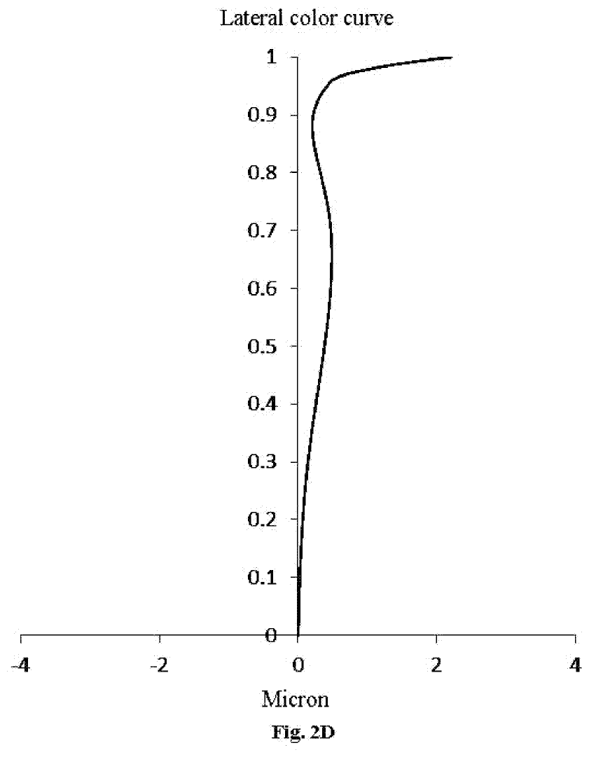

An optical imaging lens group according to embodiment 1 of the disclosure will be described below with reference to FIG. 1 to FIG. 2D. FIG. 1 is a structure diagram of an optical imaging lens group according to embodiment 1 of the disclosure.

As shown in FIG. 1, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has positive refractive power, an object-side surface S3 thereof is a concave surface, and an image-side surface S4 is a convex surface. The third lens E3 has positive refractive power, an object-side surface S5 thereof is a convex surface, and an image-side surface S6 is a convex surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a convex surface. The seventh lens E7 has negative refractive power, an object-side surface S13 thereof is a concave surface, and an image-side surface S14 is a convex surface. The eighth lens E8 has negative refractive power, an object-side surface S15 thereof is a concave surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 1 shows a surface type, curvature radius, thickness, material and cone coefficient of each lens of the optical imaging lens group according to embodiment 1. Units of the curvature radius and the thickness are millimeter (mm).

TABLE 1

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 4.5274 | 0.5355 | 1.55 | 64.1 | −0.2827 |
| S2 | Aspherical | −118.4737 | 0.0995 | | | −98.6489 |
| S3 | Aspherical | −58.9581 | 0.2057 | 1.65 | 23.5 | −78.1865 |
| S4 | Aspherical | −55.6458 | 0.0300 | | | 97.9819 |
| S5 | Aspherical | 3.4556 | 0.5521 | 1.55 | 64.1 | −0.0431 |
| S6 | Aspherical | −28.9187 | 0.0628 | | | −83.1354 |
| STO | Spherical | Infinite | 0.1033 | | | |
| S7 | Aspherical | 26.6154 | 0.3444 | 1.66 | 21.5 | −59.2954 |
| S8 | Aspherical | 2.2498 | 0.6134 | | | −0.6321 |
| S9 | Aspherical | 11.0075 | 0.7538 | 1.65 | 23.5 | −16.3183 |
| S10 | Aspherical | −4.6146 | 0.5839 | | | 5.1174 |
| S11 | Aspherical | −3.6929 | 0.2000 | 1.66 | 21.5 | 3.0358 |
| S12 | Aspherical | −6.0148 | 0.6283 | | | 1.2361 |
| S13 | Aspherical | −3.6057 | 0.2003 | 1.55 | 64.1 | 1.3024 |
| S14 | Aspherical | −4.5387 | 0.1748 | | | −67.8912 |
| S15 | Aspherical | −738.7911 | 0.5968 | 1.55 | 64.1 | −99.0000 |
| S16 | Aspherical | 4.0864 | 1.1059 | | | −32.9699 |
| S17 | Spherical | Infinite | 0.2100 | 1.52 | 64.1 | |
| S18 | Spherical | Infinite | 0.2997 | | | |
| S19 | Spherical | Infinite | | | | |

From Table 1, it can be seen that both the object-side surface and the image-side surface of any lens in the first lens E1 to the eighth lens E8 are aspherical surfaces. In the embodiment, the surface type x of each aspherical lens may be defined, by use of, but not limited to, the following aspherical surface formula:

$$x = \frac{{ch}^{2}}{1 + \sqrt{1 - ( k + 1 ) {c}^{2} {h}^{2}}} + \sum {Aih}^{′} \qquad ( 1 )$$

wherein, x is the distance vector height from a vertex of the aspherical surface when the aspherical surface is at a height of h along the optical axis direction; c is a paraxial curvature of the aspherical surface, c=1/R (namely, the paraxial curvature c is a reciprocal of the curvature radius R in Table 1); k is the cone coefficient (given in Table 1); and Ai is an ith-order correction coefficient of the aspherical surface. Table 2 shows higher-order coefficients A₄, A₆, A₈, A₁₀, A₁₂, A₁₄, A₁₆ and A₁₈ that can be used for each of aspherical mirror surfaces S1 and S16 in embodiment 1.

TABLE 2

| Surface | | | | | | | | |
|---|---|---|---|---|---|---|---|---|
| number | A4 | A6 | A8 | A10 | A12 | A14 | A16 | A18 |
| S1 | −7.2699E−03 | −4.1036E−03 | 7.7967E−03 | −6.3714E−03 | 3.5441E−03 | −1.2506E−03 | 2.3854E−04 | −1.8356E−05 |
| S2 | 3.0894E−02 | −8.0500E−02 | 1.0177E−01 | −7.5472E−02 | 3.5005E−02 | −1.0137E−02 | 1.6892E−03 | −1.2366E−04 |
| S3 | 4.9542E−02 | −1.4180E−01 | 1.9907E−01 | −1.6602E−01 | 3.3955E−02 | −2.5246E−02 | 4.1848E−03 | −2.9872E−04 |
| S4 | −1.0364E−02 | 1.2705E−02 | 1.0356E−02 | −2.7686E−02 | 1.9599E−02 | −6.1526E−03 | 8.5498E−04 | −4.2107E−05 |
| S5 | −3.4972E−02 | 1.0404E−01 | −1.3558E−01 | 9.9607E−02 | −5.1063E−02 | 1.6445E−02 | −2.6832E−03 | 1.2989E−04 |
| S6 | 3.2225E−02 | −7.7365E−02 | 7.0036E−02 | −5.3765E−02 | 2.8047E−02 | −8.0481E−03 | 9.5991E−04 | −8.7278E−06 |
| S7 | 2.7328E−02 | −1.1036E−01 | 1.5573E−01 | −1.2516E−01 | 5.9345E−02 | −7.3929E−03 | −5.9447E−03 | 1.9833E−03 |
| S8 | −4.6195E−03 | −5.2088E−02 | 1.1116E−01 | −8.9641E−02 | 2.9034E−02 | 1.5297E−02 | −1.6882E−02 | 4.3086E−03 |
| S9 | 1.1700E−03 | −1.4430E−02 | 2.3587E−02 | −4.3492E−02 | 5.4226E−02 | −3.9085E−02 | 1.5127E−02 | −2.3504E−03 |
| S10 | −8.0043E−04 | −1.0676E−02 | −1.2018E−02 | 2.0214E−02 | −1.9183E−02 | 1.2004E−02 | −4.3348E−03 | 7.0453E−04 |
| S11 | 1.5388E−02 | −4.0057E−03 | 2.1026E−03 | −6.4628E−02 | 9.4905E−02 | −6.2101E−02 | 2.0071E−02 | −2.5724E−03 |
| S12 | −4.4153E−03 | 3.4669E−02 | −3.3766E−02 | −5.4597E−03 | 3.0913E−02 | −2.1475E−02 | 6.3247E−03 | −7.0200E−04 |
| S13 | 1.7676E−02 | −5.6757E−02 | 8.4849E−02 | −1.0610E−01 | 8.3155E−02 | −3.5875E−02 | 7.8576E−03 | −6.8578E−04 |
| S14 | 2.0003E−02 | 3.1493E−02 | −7.3811E−02 | 5.7991E−02 | −2.3187E−02 | 5.0860E−03 | −5.8475E−04 | 2.7628E−05 |
| S15 | −3.2828E−02 | 3.0745E−02 | −2.6035E−02 | 1.3753E−02 | −4.0943E−03 | 6.8760E−04 | −6.1417E−05 | 2.2780E−06 |
| S16 | −5.6787E−02 | 2.5918E−02 | −1.2403E−02 | 4.4065E−03 | −1.0455E−03 | 1.5297E−04 | −1.2213E−05 | 3.9379E−07 |

Table 3 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 1.

TABLE 3

| | | | |
|---|---|---|---|
| ImgH (mm) | 3.38 | f3 (mm) | 5.69 |
| TTL (mm) | 7.30 | f4 (mm) | −3.77 |
| HFOV (°) | 25.2 | f5 (mm) | 5.14 |
| f (mm) | 7.00 | f6 (mm) | −15.09 |
| f1 (mm) | 8.00 | f7 (mm) | −34.77 |
| f2 (mm) | 1500.16 | f8 (mm) | −7.44 |

FIG. 2A shows a longitudinal aberration curve of the optical imaging lens group according to embodiment 1 to represent deviations of a convergence focal point after light with different wavelengths passes through the lens. FIG. 2B shows an astigmatism curve of the optical imaging lens group according to embodiment 1 to represent a tangential image surface curvature and a sagittal image surface curvature. FIG. 2C shows a distortion curve of the optical imaging lens group according to embodiment 1 to represent distortion values corresponding to different image heights. FIG. 2D shows a lateral color curve of the optical imaging lens group according to embodiment 1 to represent deviations of different image heights on the imaging surface after the light passes through the lens. According to FIG. 2A to FIG. 2D, it can be seen that the optical imaging lens group provided in embodiment 1 may achieve high imaging quality.

### Embodiment 2

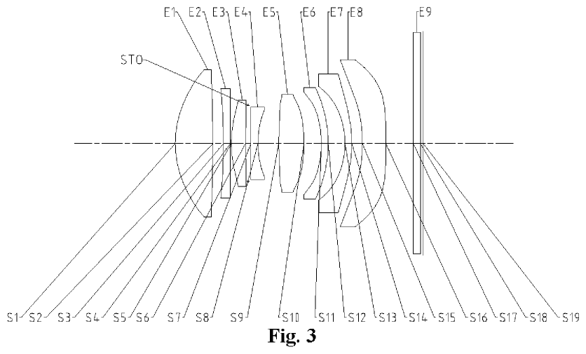

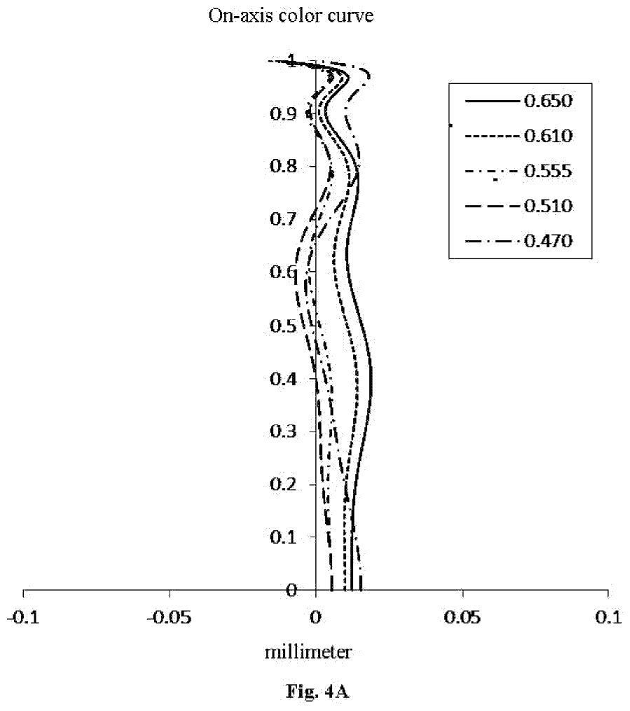

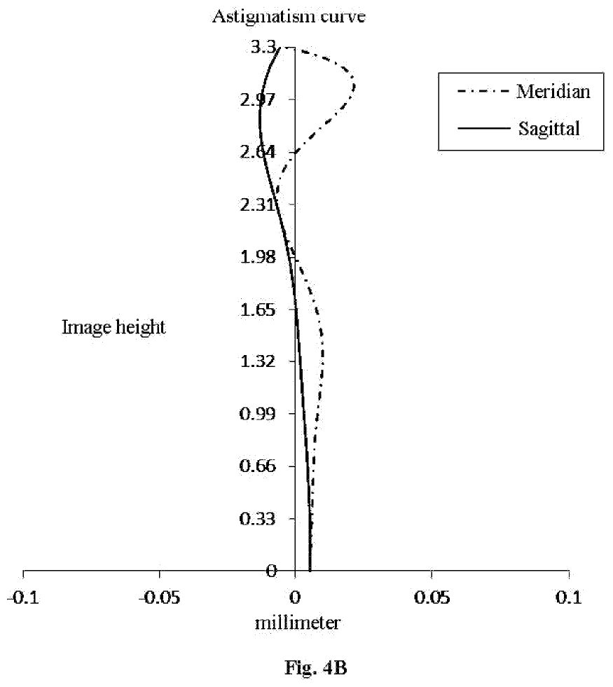

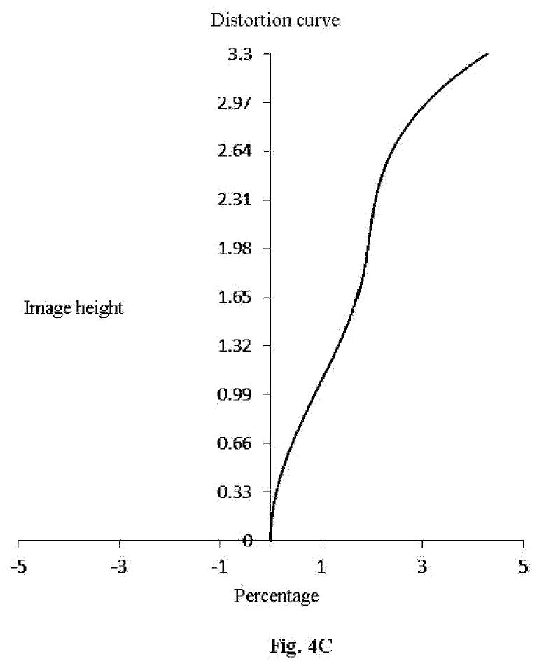

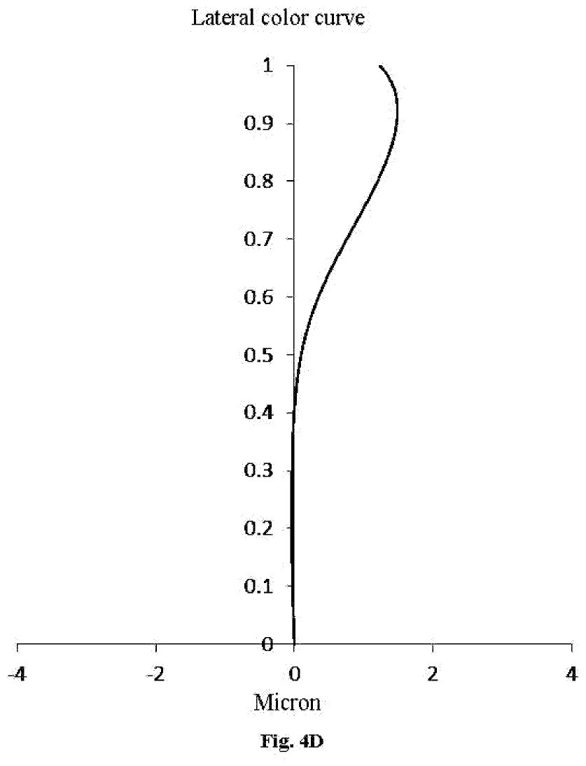

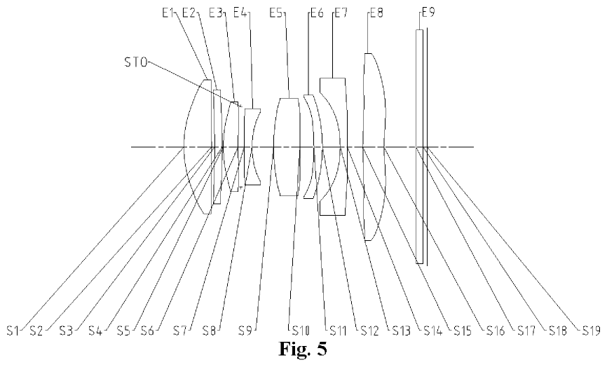

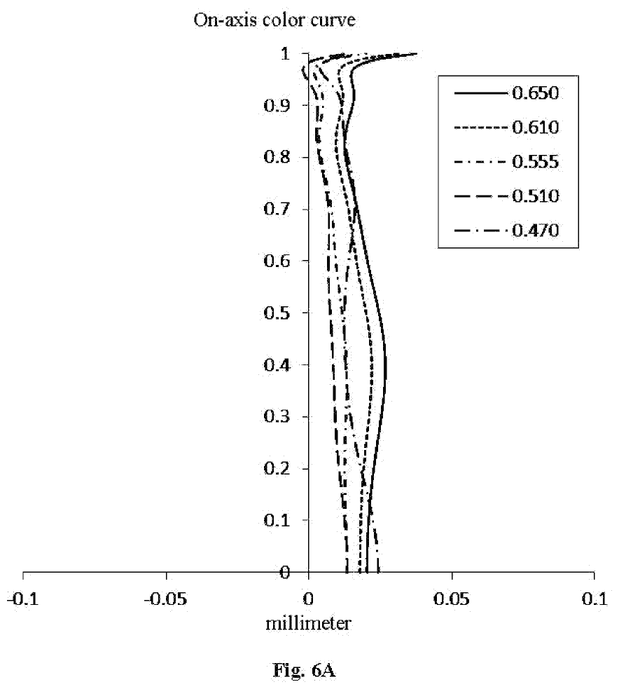

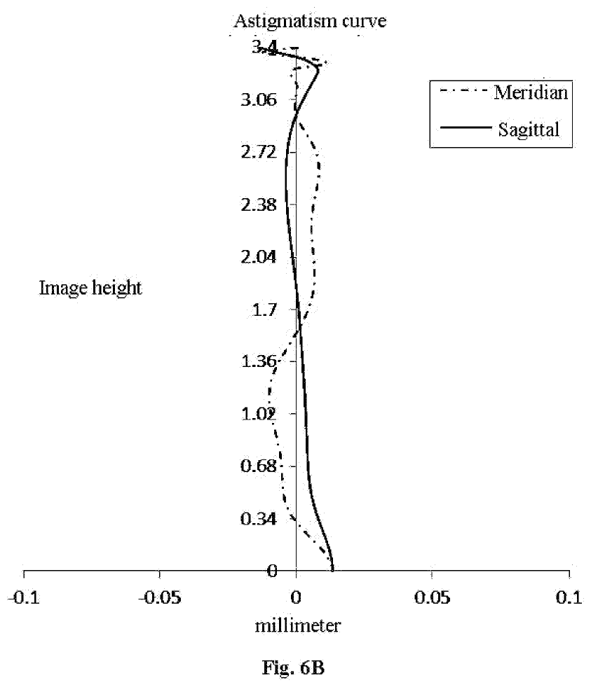

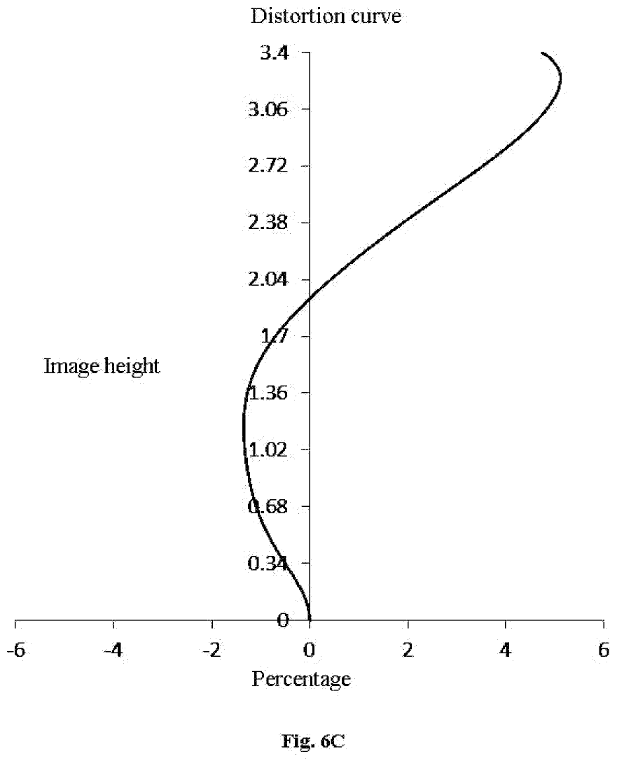

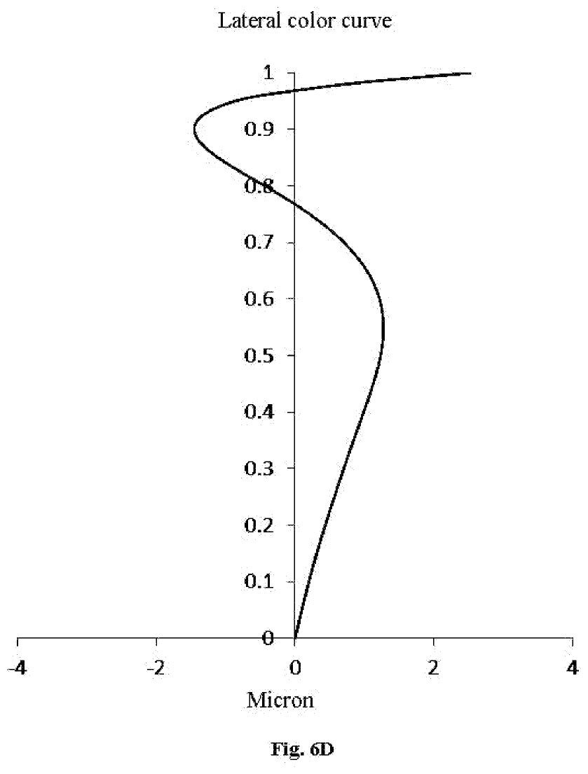

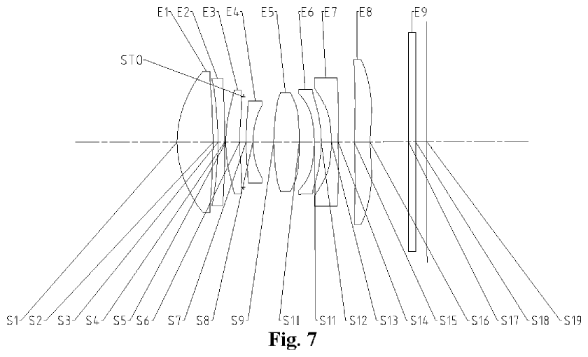

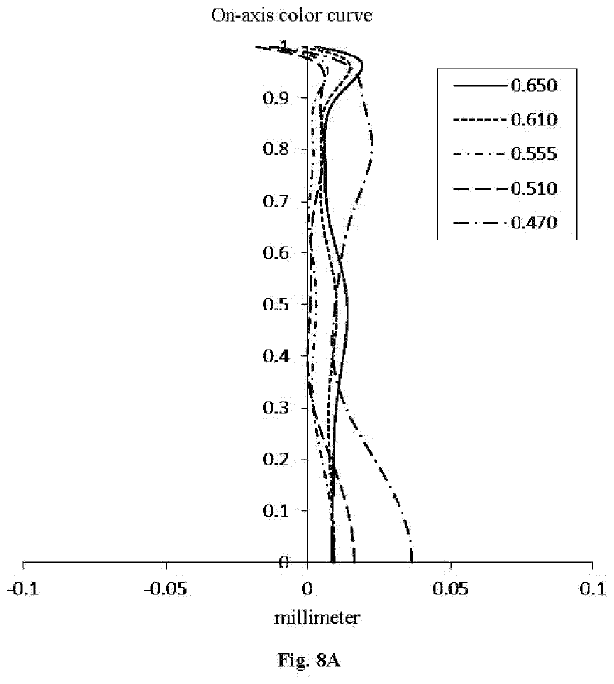

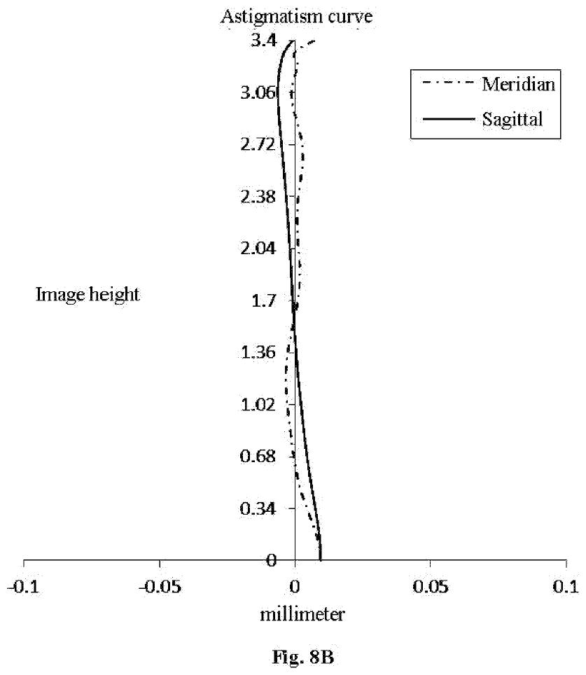

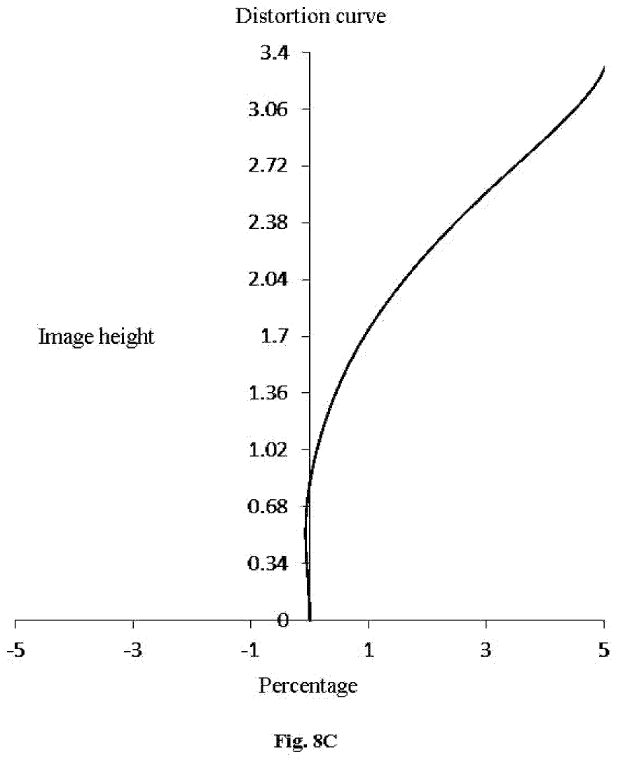

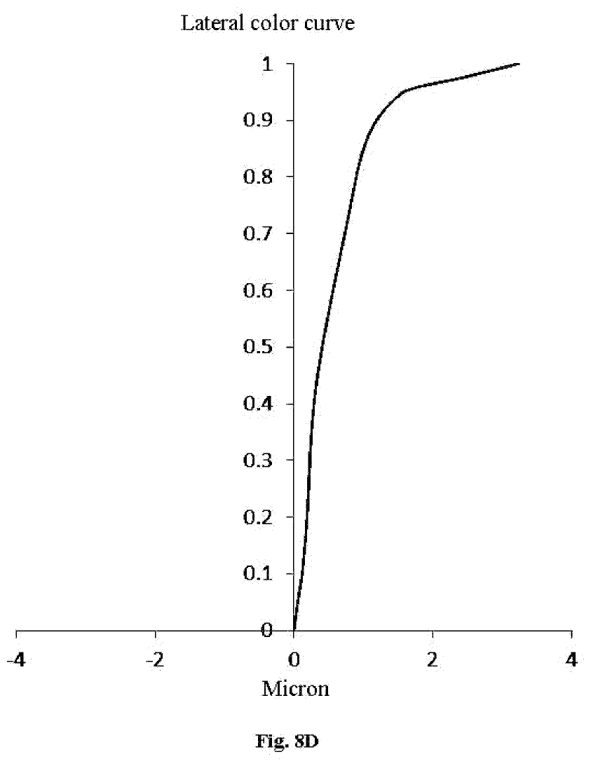

An optical imaging lens group according to embodiment 2 of the disclosure will be described below with reference to FIG. 3 to FIG. 4D. In the embodiment and the following embodiments, part of descriptions similar to those about embodiment are omitted for simplicity. FIG. 3 is a structure diagram of an optical imaging lens group according to embodiment 2 of the disclosure.

As shown in FIG. 3, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has positive refractive power, an object-side surface S5 thereof is a convex surface, and an image-side surface S6 is a concave surface. The fourth lens E4 has negative refractive power, an object-side surface S7 thereof is a concave surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a convex surface. The seventh lens E7 has negative refractive power, an object-side surface S13 thereof is a concave surface, and an image-side surface S14 is a convex surface. The eighth lens E8 has negative refractive power, an object-side surface S15 thereof is a concave surface, and an image-side surface S16 is a convex surface. The optical filter E9 has an object-side surface S17 and an image-side surface S18. Light from an object sequentially penetrates through each of the surfaces S1 to S18 and is finally imaged on the imaging surface S19.

Table 4 shows a surface type, curvature radius, thickness, material and cone coefficient of each lens of the optical imaging lens group according to embodiment 2. Units of the curvature radius and the thickness are millimeter (mm). Table 5 shows high-order coefficients applied to each aspherical mirror surface in embodiment 2. A surface type of each aspherical surface may be defined by formula (1) given in embodiment 1. Table 6 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 2.

TABLE 4

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 2.9500 | 1.1184 | 1.55 | 64.1 | −0.2863 |
| S2 | Aspherical | −33.7361 | 0.3173 | | | −98.7058 |
| S3 | Aspherical | −13.0186 | 0.2007 | 1.65 | 23.5 | −76.3180 |
| S4 | Aspherical | −194.1959 | 0.0330 | | | 97.9819 |
| S5 | Aspherical | 3.5901 | 0.4162 | 1.55 | 64.1 | −0.0431 |
| S6 | Aspherical | 17.8741 | 0.0853 | | | 10.0332 |
| STO | Spherical | Infinite | 0.0770 | | | |
| S7 | Aspherical | −999.5632 | 0.2099 | 1.66 | 21.5 | −59.2954 |
| S8 | Aspherical | 2.6941 | 0.6169 | | | −0.3259 |
| S9 | Aspherical | 10.2928 | 0.7533 | 1.65 | 23.5 | −16.3183 |
| S10 | Aspherical | −4.8377 | 0.5188 | | | 5.3209 |
| S11 | Aspherical | −3.0695 | 0.2000 | 1.66 | 21.5 | 1.5243 |
| S12 | Aspherical | −3.7902 | 0.4979 | | | 1.2710 |
| S13 | Aspherical | −2.4629 | 0.2040 | 1.55 | 64.1 | 0.5945 |
| S14 | Aspherical | −3.5107 | 0.3154 | | | −6.8463 |
| S15 | Aspherical | −4.6886 | 0.6951 | 1.55 | 64.1 | −0.1359 |
| S16 | Aspherical | −229.9568 | 0.8166 | | | −45.8587 |
| S17 | Spherical | Infinite | 0.2100 | 1.52 | 64.1 | |
| S18 | Spherical | Infinite | 0.0830 | | | |
| S19 | Spherical | Infinite | | | | |

TABLE 5

| Surface | | | | | | | | |
|---|---|---|---|---|---|---|---|---|
| number | A4 | A6 | A8 | A10 | A12 | A14 | A16 | A18 |
| S1 | −9.5530E−04 | 1.0230E−03 | −2.5937E−03 | 1.9958E−03 | −8.4689E−04 | 1.9268E−04 | −2.0988E−05 | 8.1987E−07 |
| S2 | 1.3634E−02 | −2.0361E−02 | 1.6505E−02 | −9.4394E−03 | 3.5814E−03 | −8.1208E−04 | 9.8596E−05 | −4.9361E−06 |
| S3 | 3.2636E−02 | −7.7726E−02 | 1.1033E−01 | −1.0218E−01 | 6.0070E−02 | −2.1364E−02 | 4.1574E−03 | −3.3708E−04 |
| S4 | −5.7542E−03 | −3.4794E−02 | 1.2640E−01 | −1.7210E−01 | 1.2388E−01 | −5.0298E−02 | 1.0862E−02 | −9.5933E−04 |
| S5 | −1.7120E−02 | −1.8270E−02 | 1.3063E−01 | −2.1001E−01 | 1.7217E−01 | −8.6707E−02 | 2.5704E−02 | −3.3229E−03 |
| S6 | 5.1065E−02 | −1.0127E−01 | 6.5828E−03 | 2.5658E−01 | −4.8330E−01 | 4.0692E−01 | −1.6689E−01 | 2.7170E−02 |
| S7 | 3.9409E−02 | −1.5101E−01 | 1.6759E−01 | 8.0763E−02 | −4.6221E−01 | 5.5851E−01 | −3.0269E−01 | 6.3468E−02 |
| S8 | 1.5004E−02 | −1.1626E−01 | 3.2888E−01 | −5.6092E−01 | 6.7260E−01 | −5.2602E−01 | 2.4322E−01 | −5.0807E−02 |
| S9 | −7.5924E−03 | 2.2186E−02 | −8.0279E−02 | 1.2555E−01 | −1.1246E−01 | 5.6894E−02 | −1.4182E−02 | 1.3188E−03 |
| S10 | −1.7957E−02 | 4.7040E−02 | −1.2946E−01 | 1.7328E−01 | −1.4573E−01 | 7.5147E−02 | −2.1701E−02 | 2.7574E−03 |
| S11 | −2.8278E−02 | 9.3629E−02 | −1.2221E−01 | 5.5611E−02 | 1.3043E−02 | −2.6108E−02 | 1.0871E−02 | −1.5305E−03 |
| S12 | −2.7616E−02 | 8.7737E−02 | −9.8276E−02 | 5.1591E−02 | −7.4348E−03 | −4.8325E−03 | 2.3178E−03 | −2.9915E−04 |
| S13 | 5.2147E−03 | −6.6477E−03 | 4.1098E−03 | −2.4178E−03 | 9.5969E−04 | −1.9239E−04 | 1.5858E−05 | −2.5729E−07 |
| S14 | 3.0265E−02 | −4.7387E−02 | 3.4591E−02 | −1.4936E−02 | 4.1868E−03 | −7.2887E−04 | 6.7867E−05 | −2.4048E−06 |
| S15 | 6.3623E−03 | −2.3625E−02 | 1.2500E−02 | −2.8878E−03 | 4.0845E−04 | −4.4962E−05 | 3.2631E−06 | −7.9254E−08 |
| S16 | −2.4980E−02 | −5.5959E−04 | 8.1373E−05 | 5.1176E−05 | −1.2628E−05 | 1.2862E−06 | −7.8274E−08 | 1.9262E−09 |

TABLE 6

| | | | |
|---|---|---|---|
| ImgH (mm) | 3.30 | f3 (mm) | 8.15 |
| TTL (mm) | 7.37 | f4 (mm) | −4.09 |
| HFOV (°) | 24.4 | f5 (mm) | 5.21 |
| f (mm) | 7.00 | f6 (mm) | −27.63 |
| f1 (mm) | 5.02 | f7 (mm) | −16.23 |
| f2 (mm) | −21.66 | f8 (mm) | −8.78 |

FIG. 4A shows a longitudinal aberration curve of the optical imaging lens group according to embodiment 2 to represent deviations of a convergence focal point after light with different wavelengths passes through the lens. FIG. 4B shows an astigmatism curve of the optical imaging lens group according to embodiment 2 to represent a tangential image surface curvature and a sagittal image surface curvature. FIG. 4C shows a distortion curve of the optical imaging lens group according to embodiment 2 to represent distortion values corresponding to different image heights. FIG. 4D shows a lateral color curve of the optical imaging lens group according to embodiment 2 to represent deviations of different image heights on the imaging surface after the light passes through the lens. According to FIG. 4A to FIG. 4D, it can be seen that the optical imaging lens group provided in embodiment 2 may achieve high imaging quality.

### Embodiment 3

An optical imaging lens group according to embodiment 3 of the disclosure will be described below with reference to FIG. 5 to FIG. 6D. FIG. 5 is a structure diagram of an optical imaging lens group according to embodiment 3 of the disclosure.

As shown in FIG. 5, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has positive refractive power, an object-side surface S3 thereof is a concave surface, and an image-side surface S4 is a convex surface. The third lens E3 has positive refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a concave surface. The sixth lens E6 has positive refractive power, an object-side surface S11 thereof is a concave surface, and an image-side surface S12 is a convex surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 7 shows a surface type, curvature radius, thickness, material and cone coefficient of each lens of the optical imaging lens group according to embodiment 3. Units of the curvature radius and the thickness are millimeter (mm). Table 8 shows high-order coefficients applied to each aspherical mirror surface in embodiment 3. A surface type of each aspherical surface may be defined by formula (1) given in embodiment 1. Table 9 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 3.

TABLE 7

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 3.0089 | 0.7925 | 1.55 | 64.1 | −0.2827 |
| S2 | Aspherical | −83.0265 | 0.0923 | | | −98.6551 |
| S3 | Aspherical | −31.5185 | 0.2159 | 1.65 | 23.5 | −16.3559 |
| S4 | Aspherical | −25.3518 | 0.0300 | | | 97.9819 |
| S5 | Aspherical | 3.4150 | 0.4247 | 1.55 | 64.1 | −0.0431 |
| S6 | Aspherical | 20.3057 | 0.0787 | | | 10.0831 |
| STO | Spherical | Infinite | 0.0989 | | | |
| S7 | Aspherical | 70.9587 | 0.2237 | 1.66 | 21.5 | −59.2954 |
| S8 | Aspherical | 2.1627 | 0.6171 | | | −0.3467 |
| S9 | Aspherical | 4.5265 | 0.7566 | 1.65 | 23.5 | −16.3183 |
| S10 | Aspherical | 19.2513 | 0.4019 | | | −99.0000 |
| S11 | Aspherical | −7.0805 | 0.2438 | 1.66 | 21.5 | 15.0001 |
| S12 | Aspherical | −4.2484 | 0.5126 | | | 1.2876 |
| S13 | Aspherical | −2.7463 | 0.2003 | 1.55 | 64.1 | 0.9719 |
| S14 | Aspherical | −29.7910 | 0.4410 | | | 67.8678 |
| S15 | Aspherical | 4.9795 | 0.6057 | 1.55 | 64.1 | −99.0000 |
| S16 | Aspherical | 3.1997 | 0.9192 | | | −57.2464 |
| S17 | Spherical | Infinite | 0.2100 | 1.52 | 64.1 | |
| S18 | Spherical | Infinite | 0.1152 | | | |
| S19 | Spherical | Infinite | | | | |

TABLE 8

| Surface | | | | | | | | |
|---|---|---|---|---|---|---|---|---|
| number | 44 | A6 | A8 | A10 | A12 | A14 | A16 | A18 |
| S1 | −9.0836E−03 | 1.0629E−03 | −1.5471E−03 | −8.4476E−05 | 8.5830E−04 | −4.2766E−04 | 8.5039E−05 | −6.0872E−06 |
| S2 | 1.1017E−02 | −3.6523E−02 | 4.0328E−02 | −2.4453E−02 | 1.0409E−02 | −3.2419E−03 | 6.2849E−04 | −5.3469E−05 |
| S3 | 4.3095E−02 | −1.2071E−01 | 1.7497E−01 | −1.5269E−01 | 8.2904E−02 | −2.7552E−02 | 5.1304E−03 | −4.0846E−04 |
| S4 | −4.6784E−03 | −1.0461E−02 | 6.4966E−02 | −1.0551E−01 | 8.3047E−02 | −3.5354E−02 | 7.8599E−03 | −7.1458E−04 |
| S5 | −3.8294E−02 | 1.0178E−01 | −9.2592E−02 | 1.0560E−02 | 2.8815E−02 | −1.7229E−02 | 2.6886E−03 | 1.1690E−04 |
| S6 | 2.3780E−02 | −3.3985E−02 | 1.2220E−02 | −5.2212E−02 | 9.3488E−02 | −7.2224E−02 | 2.5796E−02 | −3.5185E−03 |
| S7 | 1.2716E−02 | −8.5920E−02 | 2.1172E−01 | −3.2749E−01 | 4.0330E−01 | −3.2821E−01 | 1.4830E−01 | −2.8042E−02 |
| S8 | −2.7719E−02 | −4.6292E−02 | 2.2044E−01 | −3.2345E−01 | 3.5609E−01 | −2.7346E−01 | 1.2414E−01 | −2.4868E−02 |
| S9 | 4.8969E−03 | −2.8896E−02 | 5.5168E−02 | −8.8459E−02 | 1.0187E−01 | −6.3452E−02 | 1.9914E−02 | −2.5171E−03 |
| S10 | −1.8157E−02 | 1.1912E−02 | −8.4097E−02 | 1.2981E−01 | −1.2537E−01 | 8.1231E−02 | −2.9027E−02 | 4.1450E−03 |
| S11 | −2.6997E−02 | 1.1282E−01 | −3.1300E−01 | 4.8463E−01 | −5.0885E−01 | 3.2631E−01 | −1.1074E−01 | 1.5122E−02 |
| S12 | −1.6511E−02 | 9.4153E−02 | −2.0162E−01 | 2.6626E−01 | −2.3217E−01 | 1.2510E−01 | −3.6909E−02 | 4.5264E−03 |
| S13 | 9.8688E−02 | −2.1495E−01 | 1.5178E−01 | −2.4620E−02 | −1.8476E−02 | 8.8063E−03 | −1.1461E−03 | 1.3100E−05 |
| S14 | 1.0374E−01 | −1.9627E−01 | 1.6217E−01 | −7.5378E−02 | 2.1072E−02 | −3.5093E−03 | 3.2060E−04 | −1.2397E−05 |
| S15 | −4.7750E−02 | 3.5572E−02 | −1.9037E−02 | 6.8620E−03 | −1.5332E−03 | 2.0284E−04 | −1.4514E−05 | 4.2993E−07 |
| S16 | −4.3638E−02 | 3.1732E−03 | 7.6209E−03 | −4.6054E−03 | 1.3061E−03 | −2.0424E−04 | 1.6910E−05 | −5.8046E−07 |

TABLE 9

| | | | |
|---|---|---|---|
| ImgH (mm) | 3.40 | f3 (mm) | 7.45 |
| TTL (mm) | 6.98 | f4 (mm) | −3.40 |
| HFOV (°) | 24.9 | f5 (mm) | 9.00 |
| f (mm) | 7.00 | f6 (mm) | 15.65 |
| f1 (mm) | 5.34 | f7 (mm) | −5.56 |
| f2 (mm) | 198.30 | f8 (mm) | −18.64 |

FIG. 6A shows a longitudinal aberration curve of the optical imaging lens group according to embodiment 3 to represent deviations of a convergence focal point after light with different wavelengths passes through the lens. FIG. 6B shows an astigmatism curve of the optical imaging lens group according to embodiment 3 to represent a tangential image surface curvature and a sagittal image surface curvature. FIG. 6C shows a distortion curve of the optical imaging lens group according to embodiment 3 to represent distortion values corresponding to different image heights. FIG. 6D shows a lateral color curve of the optical imaging lens group according to embodiment 3 to represent deviations of different image heights on the imaging surface after the light passes through the lens. According to FIG. 6A to FIG. 6D, it can be seen that the optical imaging lens group provided in embodiment 3 may achieve high imaging quality.

### Embodiment 4

An optical imaging lens group according to embodiment 4 of the disclosure will be described below with reference to FIG. 7 to FIG. 8D. FIG. 7 is a structure diagram of an optical imaging lens group according to embodiment 4 of the disclosure.

As shown in FIG. 7, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has positive refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a convex surface. The seventh lens E7 has negative refractive power, an object-side surface S13 thereof is a concave surface, and an image-side surface S14 is a concave surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 10 shows a surface type, curvature radius, thickness, material and cone coefficient of each lens of the optical imaging lens group according to embodiment 4. Units of the curvature radius and the thickness are millimeter (mm). Table 11 shows high-order coefficients applied to each aspherical mirror surface in embodiment 4. A surface type of each aspherical surface may be defined by formula (1) given in embodiment 1. Table 12 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 4.

TABLE 10

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 2.8502 | 1.0690 | 1.55 | 64.1 | −0.2827 |
| S2 | Aspherical | −11.7862 | 0.1424 | | | −98.6551 |
| S3 | Aspherical | −6.8612 | 0.2000 | 1.65 | 23.5 | −56.9737 |
| S4 | Aspherical | −37.3646 | 0.0300 | | | 97.9819 |
| S5 | Aspherical | 3.7644 | 0.4154 | 1.55 | 64.1 | −0.0431 |
| S6 | Aspherical | 9.4144 | 0.1102 | | | 10.0831 |
| STO | Spherical | Infinite | 0.0787 | | | |
| S7 | Aspherical | 9.5869 | 0.2000 | 1.66 | 21.5 | −59.2954 |
| S8 | Aspherical | 2.3092 | 0.6171 | | | −0.1839 |
| S9 | Aspherical | 5.7078 | 0.7566 | 1.65 | 23.5 | −16.3183 |
| S10 | Aspherical | −11.1661 | 0.4490 | | | 54.0990 |
| S11 | Aspherical | −3.6774 | 0.2000 | 1.66 | 21.5 | 4.2912 |
| S12 | Aspherical | −3.9611 | 0.3050 | | | 1.2876 |
| S13 | Aspherical | −3.5816 | 0.2000 | 1.55 | 64.1 | 1.3565 |
| S14 | Aspherical | 52.7048 | 0.4725 | | | 99.0000 |
| S15 | Aspherical | 5.3681 | 0.4697 | 1.55 | 64.1 | −92.6065 |
| S16 | Aspherical | 4.0382 | 1.1404 | | | −57.2464 |
| S17 | Spherical | Infinite | 0.2100 | 1.52 | 64.1 | |
| S18 | Spherical | Infinite | 0.3341 | | | |
| S19 | Spherical | Infinite | | | | |

TABLE 11

| Surface | | | | | | | | |
|---|---|---|---|---|---|---|---|---|
| number | A4 | A6 | A8 | A10 | A12 | A14 | A16 | A18 |
| S1 | −3.4371E−03 | −7.4547E−04 | 3.0957E−04 | −3.4555E−04 | 1.3587E−04 | −2.5384E−05 | 2.6551E−06 | −6.7212E−08 |
| S2 | 1.6203E−02 | −1.8690E−02 | 2.6080E−03 | 6.4402E−03 | −4.7383E−03 | 1.5308E−03 | −2.4734E−04 | 1.6115E−05 |
| S3 | 3.6720E−02 | −6.2008E−02 | 4.3100E−02 | −1.3651E−02 | 5.3913E−04 | 9.7236E−04 | −2.8509E−04 | 2.6040E−05 |
| S4 | −1.1372E−02 | 3.2587E−02 | −4.4380E−02 | 3.4129E−02 | −1.5897E−02 | 4.4931E−03 | −7.0667E−04 | 4.6795E−05 |
| S5 | −3.7655E−02 | 7.7227E−02 | −5.9200E−02 | 1.3661E−03 | 1.9466E−02 | −1.2013E−02 | 3.4191E−03 | −3.9421E−04 |
| S6 | 4.6180E−02 | −1.1088E−01 | 1.6177E−01 | −2.1485E−01 | 1.7514E−01 | −8.1116E−02 | 2.0119E−02 | −2.0900E−03 |
| S7 | 2.7016E−02 | −1.2240E−01 | 2.3256E−01 | −2.7383E−01 | 2.1502E−01 | −1.0450E−01 | 2.8129E−02 | −3.2234E−03 |
| S8 | −1.0899E−02 | −5.8974E−02 | 1.9668E−01 | −2.8158E−01 | 3.0440E−01 | −2.2773E−01 | 1.0072E−01 | −1.9655E−02 |
| S9 | 9.3597E−03 | −2.1967E−02 | 4.1606E−02 | −6.5351E−02 | 6.8859E−02 | −4.1807E−02 | 1.3444E−02 | −1.7495E−03 |
| S10 | −6.2589E−03 | −1.6409E−02 | −1.7499E−02 | 3.5704E−02 | −3.8405E−02 | 2.6124E−02 | −9.6231E−03 | 1.4847E−03 |
| S11 | 2.4792E−02 | −6.4242E−02 | 4.3808E−02 | −2.3920E−02 | −4.3010E−03 | 1.4537E−02 | −6.5691E−03 | 9.6028E−04 |
| S12 | 4.1745E−02 | −8.4954E−02 | 8.5775E−02 | −5.6005E−02 | 2.9014E−02 | −1.2034E−02 | 3.3113E−03 | −3.9861E−04 |
| S13 | 1.0632E−01 | −2.9187E−01 | 2.8660E−01 | −1.7553E−01 | 8.5948E−02 | −3.4927E−02 | 9.1770E−03 | −1.0287E−03 |
| S14 | 3.8128E−02 | −1.8945E−01 | 1.6833E−01 | −8.7977E−02 | 2.9177E−02 | −6.0785E−03 | 7.3140E−04 | −3.8976E−05 |
| S15 | −5.2081E−02 | 4.1211E−02 | −2.5574E−02 | 1.0515E−02 | −2.6300E−03 | 3.8824E−04 | −3.1188E−05 | 1.0441E−06 |
| S16 | −4.6748E−02 | 1.3671E−02 | −1.6419E−03 | −9.7527E−04 | 5.5980E−04 | −1.2412E−04 | 1.3281E−05 | −5.7447E−07 |

TABLE 12

| | | | |
|---|---|---|---|
| ImgH (mm) | 3.40 | f3 (mm) | 11.20 |
| TTL (mm) | 7.40 | f4 (mm) | −4.69 |
| HFOV (°) | 23.4 | f5 (mm) | 5.96 |
| f (mm) | 7.50 | f6 (mm) | −108.58 |
| f1 (mm) | 4.32 | f7 (mm) | −6.14 |
| f2 (mm) | −13.07 | f8 (mm) | −34.11 |

FIG. 8A shows a longitudinal aberration curve of the optical imaging lens group according to embodiment 4 to represent deviations of a convergence focal point after light with different wavelengths passes through the lens. FIG. 8B shows an astigmatism curve of the optical imaging lens group according to embodiment 4 to represent a tangential image surface curvature and a sagittal image surface curvature. FIG. 8C shows a distortion curve of the optical imaging lens group according to embodiment 4 to represent distortion values corresponding to different image heights. FIG. 8D shows a lateral color curve of the optical imaging lens group according to embodiment 4 to represent deviations of different image heights on the imaging surface after the light passes through the lens. According to FIG. 8A to FIG. 8D, it can be seen that the optical imaging lens group provided in embodiment 4 may achieve high imaging quality.

### Embodiment 5

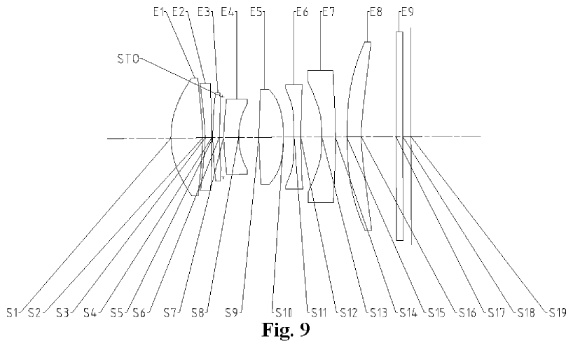

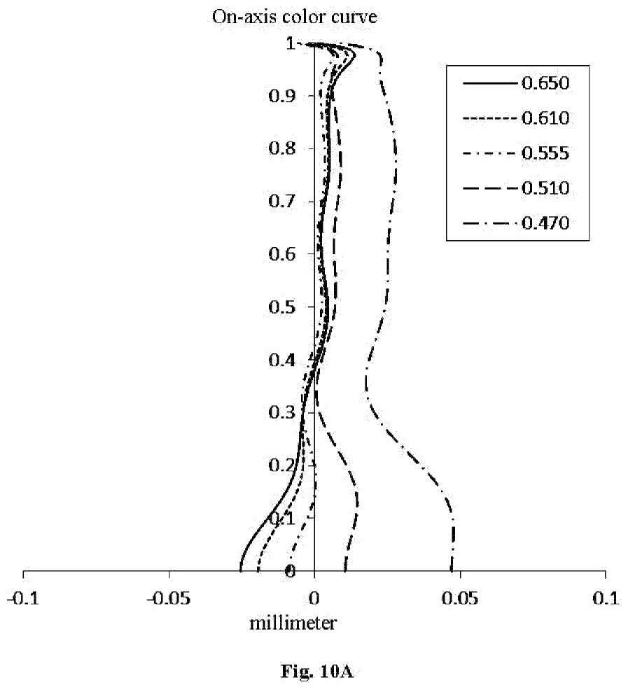

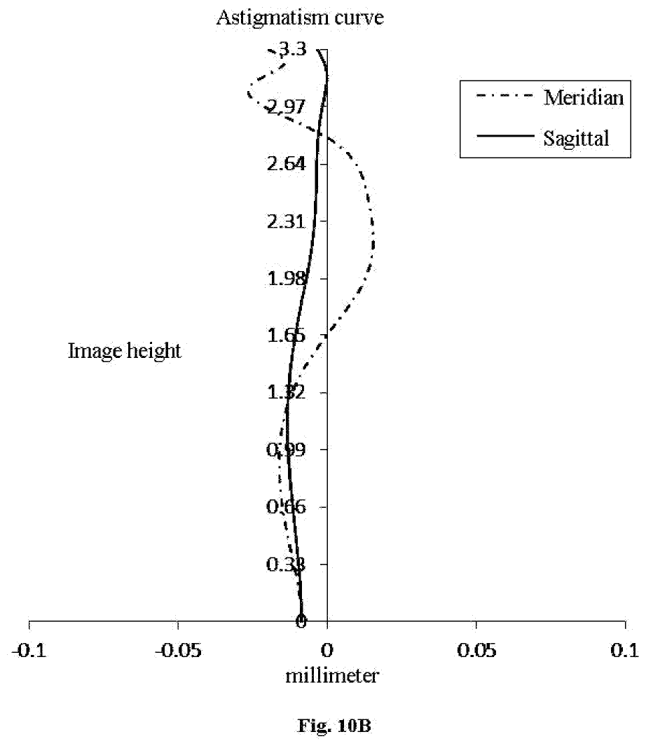

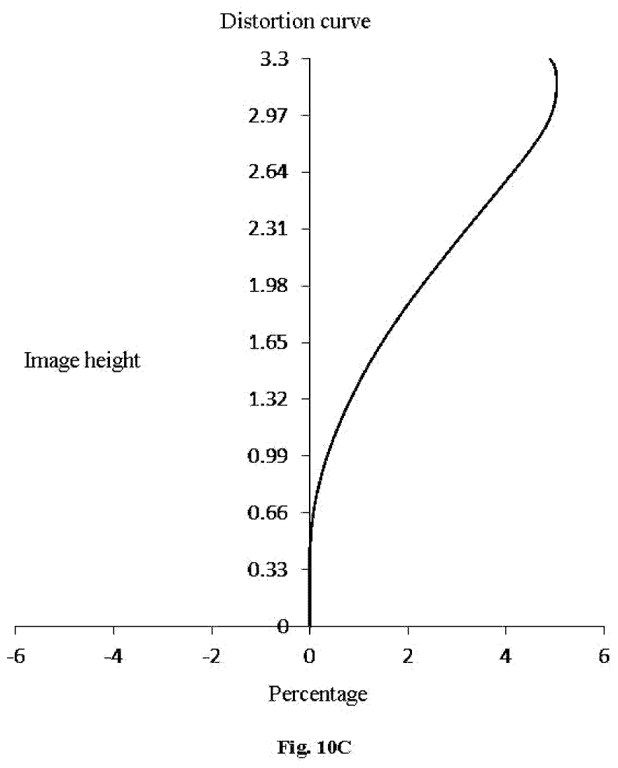

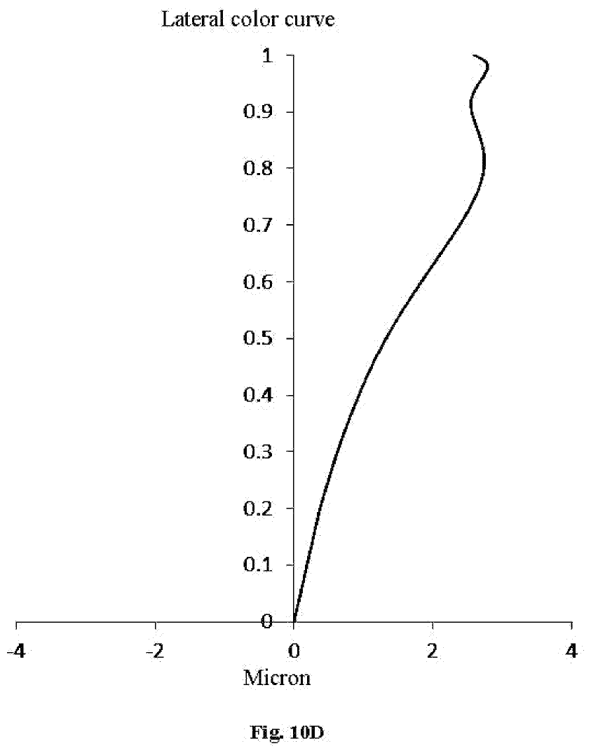

An optical imaging lens group according to embodiment 5 of the disclosure will be described below with reference to FIG. 9 to FIG. 10D. FIG. 9 is a structure diagram of an optical imaging lens group according to embodiment 5 of the disclosure.

As shown in FIG. 9, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has negative refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a concave surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 13 shows a surface type, curvature radius, thickness, material and cone coefficient of each lens of the optical imaging lens group according to embodiment 5. Units of the curvature radius and the thickness are millimeter (mm). Table 14 shows high-order coefficients applied to each aspherical mirror surface in embodiment 5. A surface type of each aspherical surface may be defined by formula (1) given in embodiment 1. Table 15 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 5.

TABLE 13

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 2.5201 | 0.9673 | 1.55 | 64.1 | −0.2827 |
| S2 | Aspherical | −4.0437 | 0.0736 | | | −98.6551 |
| S3 | Aspherical | −3.4743 | 0.2000 | 1.65 | 23.5 | −63.0150 |
| S4 | Aspherical | −27.2087 | 0.0300 | | | 97.9819 |
| S5 | Aspherical | 9.3402 | 0.2000 | 1.55 | 64.1 | −0.0431 |
| S6 | Aspherical | 8.9200 | 0.1021 | | | 10.0831 |
| STO | Spherical | Infinite | 0.0300 | | | |
| S7 | Aspherical | 3.9164 | 0.4571 | 1.66 | 21.5 | −59.2954 |
| S8 | Aspherical | 2.0164 | 0.6171 | | | −0.4445 |
| S9 | Aspherical | 14.9271 | 0.7566 | 1.65 | 23.5 | −16.3183 |
| S10 | Aspherical | −3.7743 | 0.3173 | | | 4.5496 |
| S11 | Aspherical | −10.0318 | 0.2000 | 1.66 | 21.5 | 42.9056 |
| S12 | Aspherical | 15.9142 | 0.6450 | | | 1.2876 |
| S13 | Aspherical | −5.7382 | 0.4053 | 1.55 | 64.1 | 2.3239 |
| S14 | Aspherical | −37.1194 | 0.3510 | | | 21.2899 |
| S15 | Aspherical | 12.0516 | 0.4374 | 1.55 | 64.1 | 0.8459 |
| S16 | Aspherical | 4.8345 | 1.0533 | | | −57.2464 |
| S17 | Spherical | Infinite | 0.2100 | 1.52 | 64.1 | |
| S18 | Spherical | Infinite | 0.2470 | | | |
| S19 | Spherical | Infinite | | | | |

TABLE 14

| Surface | | | | | | | | |
|---|---|---|---|---|---|---|---|---|
| number | A4 | A6 | A8 | A10 | A12 | A14 | A16 | A18 |
| S1 | −1.1609E−03 | −9.3555E−03 | 1.4774E−02 | −1.4789E−02 | 8.9131E−03 | −3.2779E−03 | 6.7654E−04 | −5.9381E−05 |
| S2 | −1.1892E−02 | 6.3043E−02 | −1.3940E−01 | 1.5215E−01 | −9.2206E−02 | 3.1813E−02 | −5.8642E−03 | 4.4928E−04 |
| S3 | 1.7780E−02 | 3.2333E−02 | −1.6631E−01 | 2.2550E−01 | −1.5063E−01 | 5.4763E−02 | −1.0433E−02 | 8.2155E−04 |
| S4 | −7.3093E−02 | 3.4915E−01 | −6.8872E−01 | 7.1506E−01 | −4.2277E−01 | 1.4294E−01 | −2.5617E−02 | 1.8709E−03 |
| S5 | −3.9666E−02 | 9.4109E−02 | 1.8820E−01 | −7.2532E−01 | 8.6274E−01 | −5.0809E−01 | 1.5199E−01 | −1.8597E−02 |
| S6 | 1.2224E−01 | −7.6337E−01 | 2.1053E+00 | −3.2861E+00 | 2.9876E+00 | −1.5804E+00 | 4.5358E−01 | −5.4911E−02 |
| S7 | 9.6033E−02 | −5.3937E−01 | 1.3589E+00 | −2.0052E+00 | 1.7915E+00 | −9.4495E−01 | 2.6929E−01 | −3.1768E−02 |
| S8 | −2.5643E−02 | −5.4057E−02 | 2.7983E−01 | −4.4813E−01 | 4.2907E−01 | −2.6398E−01 | 1.0295E−01 | −2.0160E−02 |
| S9 | 1.0558E−02 | −3.5485E−02 | 8.1329E−02 | −1.3443E−01 | 1.4565E−01 | −9.8359E−02 | 3.5991E−02 | −5.2846E−03 |
| S10 | 2.8666E−02 | −9.9449E−02 | 1.0978E−01 | −6.2706E−02 | 2.5532E−03 | 1.7988E−02 | −9.6317E−03 | 1.6825E−03 |
| S11 | 1.0948E−01 | −4.3322E−01 | 5.9400E−01 | −4.3545E−01 | 1.5212E−01 | −3.6880E−03 | −1.2304E−02 | 2.4434E−03 |
| S12 | 9.4378E−02 | −3.8948E−01 | 5.8310E−01 | −4.7792E−01 | 2.3043E−01 | −6.2834E−02 | 8.3781E−03 | −3.4759E−04 |
| S13 | −1.6773E−02 | −1.3494E−01 | 1.3405E−01 | 1.6696E−03 | −6.9770E−02 | 4.4932E−02 | −1.2082E−02 | 1.2328E−03 |
| S14 | 3.3970E−02 | −1.3139E−01 | 1.5486E−01 | −9.1819E−02 | 3.1099E−02 | −6.0946E−03 | 6.3956E−04 | −2.7512E−05 |
| S15 | −2.1501E−04 | 2.1281E−03 | 2.7997E−04 | −4.1247E−04 | 1.1369E−04 | −1.5215E−05 | 1.0623E−06 | −3.1560E−08 |
| S16 | 1.4129E−03 | −1.1035E−03 | 4.9456E−05 | 1.5202E−04 | −4.8425E−05 | 5.7329E−06 | −2.4091E−07 | 1.7113E−20 |

TABLE 15

| | | | |
|---|---|---|---|
| ImgH (mm) | 3.30 | f3 (mm) | −436.67 |
| TTL (mm) | 7.30 | f4 (mm) | −7.00 |
| HFOV (°) | 23.3 | f5 (mm) | 4.75 |
| f (mm) | 7.30 | f6 (mm) | −9.35 |
| f1 (mm) | 3.00 | f7 (mm) | −12.49 |
| f2 (mm) | −6.20 | f8 (mm) | −15.11 |

FIG. 10A shows a longitudinal aberration curve of the optical imaging lens group according to embodiment 5 to represent deviations of a convergence focal point after light with different wavelengths passes through the lens. FIG. 10B shows an astigmatism curve of the optical imaging lens group according to embodiment 5 to represent a tangential image surface curvature and a sagittal image surface curvature. FIG. 10C shows a distortion curve of the optical imaging lens group according to embodiment 5 to represent distortion values corresponding to different image heights. FIG. 10D shows a lateral color curve of the optical imaging lens group according to embodiment 5 to represent deviations of different image heights on the imaging surface after the light passes through the lens. According to FIG. 10A to FIG. 10D, it can be seen that the optical imaging lens group provided in embodiment 5 may achieve high imaging quality.

### Embodiment 6

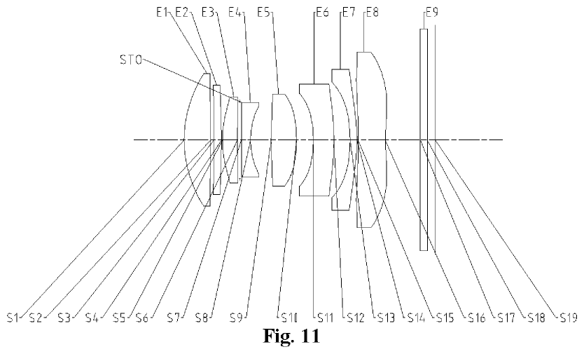

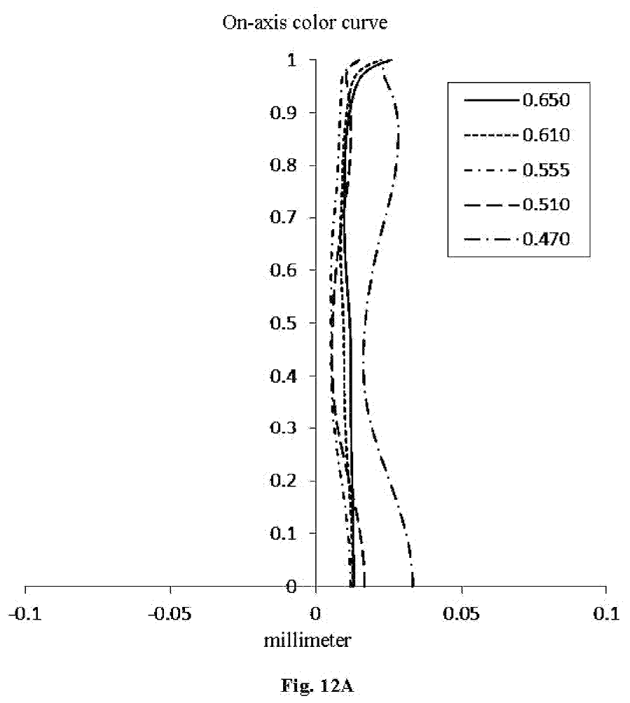

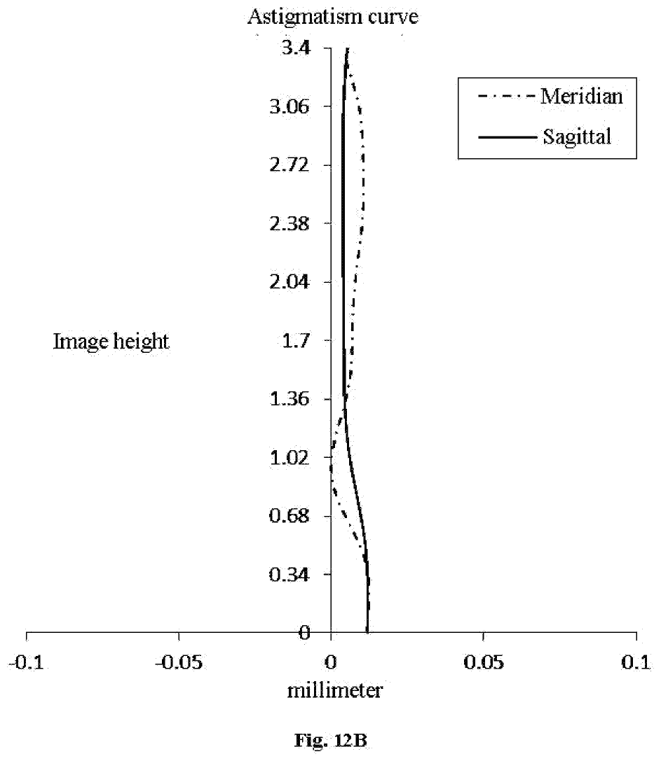

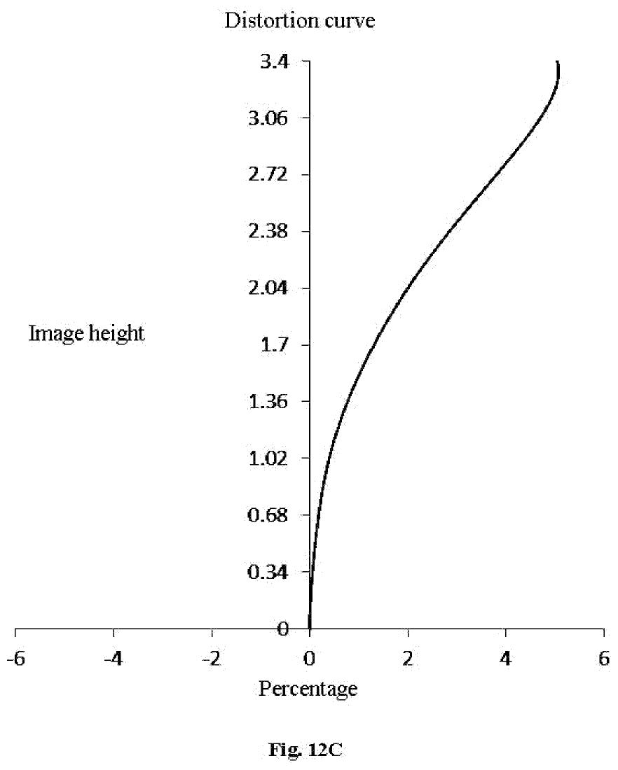

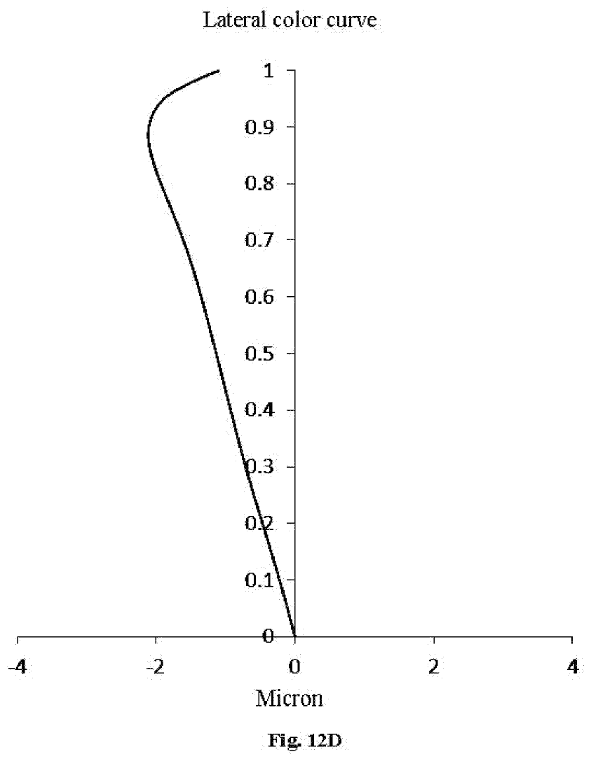

An optical imaging lens group according to embodiment 6 of the disclosure will be described below with reference to FIG. 11 to FIG. 12D. FIG. 11 is a structure diagram of an optical imaging lens group according to embodiment 6 of the disclosure.

As shown in FIG. 11, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has positive refractive power, an object-side surface S3 thereof is a concave surface, and an image-side surface S4 is a convex surface. The third lens E3 has positive refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a convex surface. The seventh lens E7 has positive refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 16 shows a surface type, curvature radius, thickness, material and cone coefficient of each lens of the optical imaging lens group according to embodiment 6. Units of the curvature radius and the thickness are millimeter (mm). Table 17 shows high-order coefficients applied to each aspherical mirror surface in embodiment 6. A surface type of each aspherical surface may be defined by formula (1) given in embodiment 1. Table 18 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 6.

TABLE 16

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 3.2833 | 0.7932 | 1.55 | 64.1 | −0.2827 |
| S2 | Aspherical | −79.4710 | 0.0970 | | | −98.6551 |
| S3 | Aspherical | −144.8933 | 0.2276 | 1.65 | 23.5 | −99.0000 |
| S4 | Aspherical | −26.0322 | 0.0300 | | | 97.9819 |
| S5 | Aspherical | 3.3567 | 0.4441 | 1.55 | 64.1 | −0.0431 |
| S6 | Aspherical | 15.6762 | 0.0829 | | | 10.0831 |
| STO | Spherical | Infinite | 0.0361 | | | |
| S7 | Aspherical | 31.5448 | 0.2736 | 1.66 | 21.5 | −59.2954 |
| S8 | Aspherical | 2.1409 | 0.6171 | | | −0.3354 |
| S9 | Aspherical | 14.6150 | 0.7566 | 1.65 | 23.5 | −16.3183 |
| S10 | Aspherical | −4.1700 | 0.5054 | | | 5.1144 |
| S11 | Aspherical | −3.3229 | 0.6088 | 1.66 | 21.5 | 2.5006 |
| S12 | Aspherical | −8.1720 | 0.4873 | | | 1.2876 |
| S13 | Aspherical | −3.6132 | 0.2049 | 1.55 | 64.1 | 1.8160 |
| S14 | Aspherical | −3.5675 | 0.0313 | | | −36.0829 |
| S15 | Aspherical | 5370.8106 | 0.8094 | 1.55 | 64.1 | 77.1265 |
| S16 | Aspherical | 4.5866 | 1.0454 | | | −57.2464 |
| S17 | Spherical | Infinite | 0.2100 | 1.52 | 64.1 | |
| S18 | Spherical | Infinite | 0.2391 | | | |
| S19 | Spherical | Infinite | | | | |

TABLE 17

| Surface | | | | | | | | |
|---|---|---|---|---|---|---|---|---|
| number | A4 | A6 | A8 | A10 | A12 | A14 | A16 | A18 |
| S1 | −3.8318E−03 | −4.2713E−04 | 5.8677E−04 | −6.6151E−04 | 4.8847E−04 | −1.9026E−04 | 3.5514E−05 | −2.4137E−06 |
| S2 | 2.1210E−02 | −4.7759E−02 | 5.0287E−02 | −3.0905E−02 | 1.1731E−02 | −2.7000E−03 | 3.4482E−04 | −1.8736E−05 |
| S3 | 3.9423E−02 | −9.6965E−02 | 1.1707E−01 | −8.7678E−02 | 4.1048E−02 | −1.1426E−02 | 1.7035E−03 | −1.0375E−04 |
| S4 | 7.8683E−03 | −1.3140E−02 | 1.8313E−02 | −2.3230E−02 | 1.7356E−02 | −6.7400E−03 | 1.2743E−03 | −9.2109E−05 |
| S5 | −1.9057E−02 | 6.0946E−02 | −7.7487E−02 | 4.3885E−02 | −1.8685E−02 | 9.4708E−03 | −4.0215E−03 | 7.4313E−04 |
| S6 | 2.1853E−02 | −4.4108E−02 | 4.4340E−02 | −8.9282E−02 | 9.8214E−02 | −5.2375E−02 | 1.2865E−02 | −1.0264E−03 |
| S7 | 2.0983E−02 | −9.0337E−02 | 1.6675E−01 | −2.3072E−01 | 2.3142E−01 | −1.4697E−01 | 5.2454E−02 | −8.0790E−03 |
| S8 | −6.2122E−03 | −4.7257E−02 | 1.4441E−01 | −1.9886E−01 | 2.0013E−01 | −1.3905E−01 | 5.7099E−02 | −1.0366E−02 |
| S9 | −4.4480E−03 | −8.7395E−03 | 1.0142E−02 | −1.5102E−02 | 1.8743E−02 | −1.2189E−02 | 3.8107E−03 | −3.9635E−04 |
| S10 | −1.1010E−02 | 3.3128E−03 | −4.3733E−02 | 7.0304E−02 | −6.3070E−02 | 3.4509E−02 | −1.0659E−02 | 1.4329E−03 |
| S11 | 8.6368E−03 | −3.7035E−02 | 5.0711E−02 | −9.0487E−02 | 9.8876E−02 | −5.9410E−02 | 1.8648E−02 | −2.3872E−03 |
| S12 | 5.6862E−03 | −1.0185E−02 | 1.3959E−02 | −1.7064E−02 | 1.3657E−02 | −5.9776E−03 | 1.3176E−03 | −1.1432E−04 |
| S13 | 8.2570E−02 | −1.5934E−01 | 1.4116E−01 | −7.6434E−02 | 2.7190E−02 | −6.0530E−03 | 3.9312E−04 | −2.3990E−05 |
| S14 | 8.3244E−02 | −1.5167E−01 | 1.1837E−01 | −5.0185E−02 | 1.2670E−02 | −1.9364E−03 | 1.6836E−04 | −6.5202E−06 |
| S15 | −1.8202E−03 | −3.5084E−02 | 3.2239E−02 | −1.3258E−02 | 3.1140E−03 | −4.3482E−04 | 3.3850E−05 | −1.1410E−06 |
| S16 | −3.6621E−02 | 1.0051E−02 | −3.1559E−03 | 8.0454E−04 | −1.3934E−04 | 1.4305E−05 | −6.7428E−07 | 3.7879E−09 |

TABLE 18

| | | | |
|---|---|---|---|
| ImgH (mm) | 3.40 | f3 (mm) | 7.73 |
| TTL (mm) | 7.50 | f4 (mm) | −3.51 |
| HFOV (°) | 24.6 | f5 (mm) | 5.11 |
| f (mm) | 7.08 | f6 (mm) | −8.98 |
| f1 (mm) | 5.80 | f7 (mm) | 200.00 |
| f2 (mm) | 49.19 | f8 (mm) | −8.41 |

FIG. 12A shows a longitudinal aberration curve of the optical imaging lens group according to embodiment 6 to represent deviations of a convergence focal point after light with different wavelengths passes through the lens. FIG. 12B shows an astigmatism curve of the optical imaging lens group according to embodiment 6 to represent a tangential image surface curvature and a sagittal image surface curvature. FIG. 12C shows a distortion curve of the optical imaging lens group according to embodiment 6 to represent distortion values corresponding to different image heights. FIG. 12D shows a lateral color curve of the optical imaging lens group according to embodiment 6 to represent deviations of different image heights on the imaging surface after the light passes through the lens. According to FIG. 12A to FIG. 12D, it can be seen that the optical imaging lens group provided in embodiment 6 may achieve high imaging quality.

### Embodiment 7

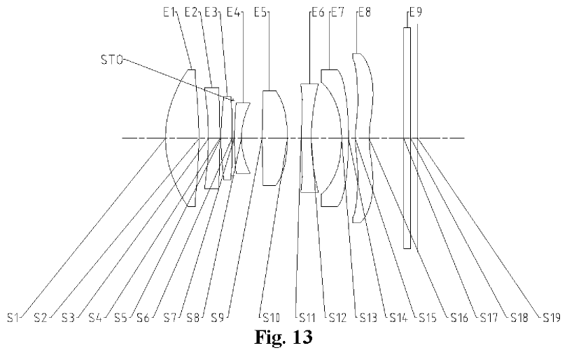

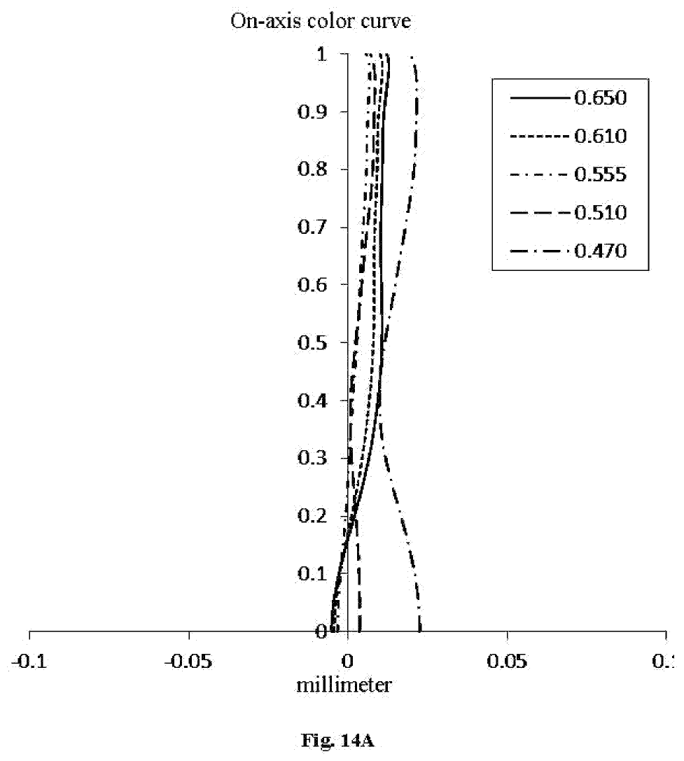

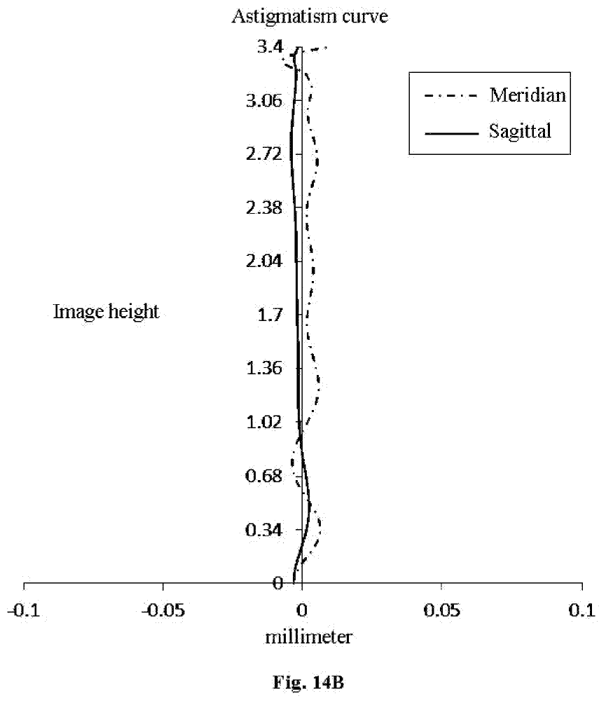

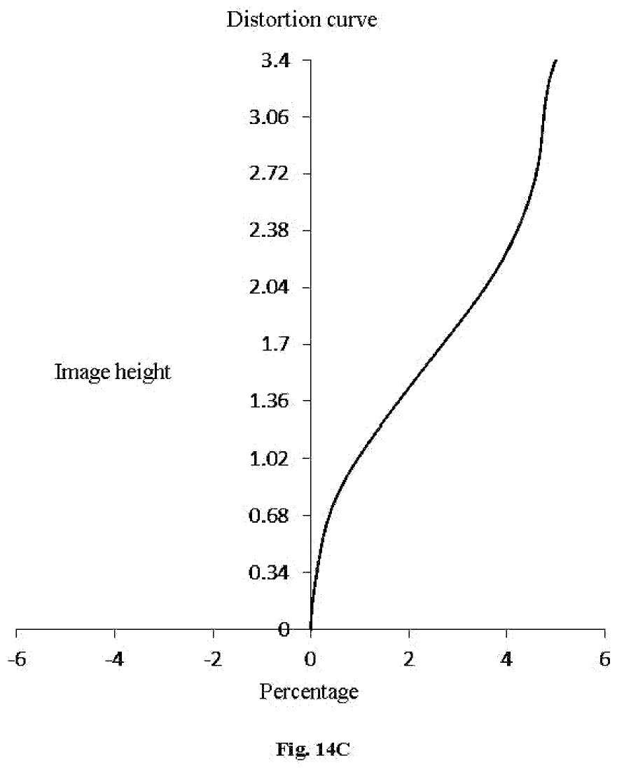

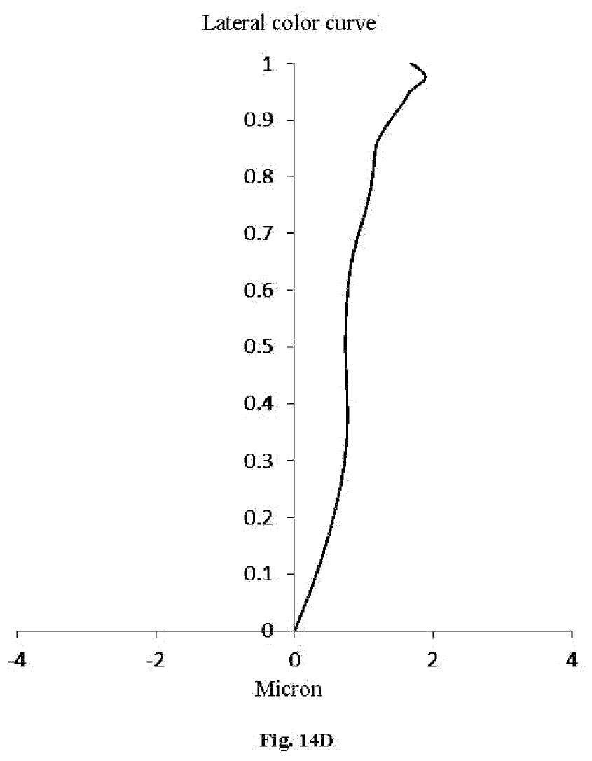

An optical imaging lens group according to embodiment 7 of the disclosure will be described below with reference to FIG. 13 to FIG. 14D. FIG. 13 is a structure diagram of an optical imaging lens group according to embodiment 7 of the disclosure.

As shown in FIG. 13, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has positive refractive power, an object-side surface S5 thereof is a convex surface, and an image-side surface S6 is a convex surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a convex surface, and an image-side surface S12 is a concave surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 19 shows a surface type, curvature radius, thickness, material and cone coefficient of each lens of the optical imaging lens group according to embodiment 7. Units of the curvature radius and the thickness are millimeter (mm). Table 20 shows high-order coefficients applied to each aspherical mirror surface in embodiment 7. A surface type of each aspherical surface may be defined by formula (1) given in embodiment 1. Table 21 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 7.

TABLE 19

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 3.1296 | 1.0000 | 1.55 | 64.1 | −0.2827 |
| S2 | Aspherical | −8.4111 | 0.2854 | | | −98.6489 |
| S3 | Aspherical | −6.5303 | 0.3323 | 1.65 | 23.5 | −47.6308 |
| S4 | Aspherical | −42.7687 | 0.0300 | | | 97.9819 |
| S5 | Aspherical | 7.1941 | 0.3318 | 1.55 | 64.1 | −0.0431 |
| S6 | Aspherical | −61.3592 | 0.0300 | | | 82.2858 |
| STO | Spherical | Infinite | 0.0300 | | | |
| S7 | Aspherical | 6.0962 | 0.2172 | 1.66 | 21.5 | −59.2954 |
| S8 | Aspherical | 2.0807 | 0.6134 | | | −0.6574 |
| S9 | Aspherical | 16.0480 | 0.7538 | 1.65 | 23.5 | −16.3183 |
| S10 | Aspherical | −4.3880 | 0.4078 | | | 4.9390 |
| S11 | Aspherical | 10.0793 | 0.2976 | 1.66 | 21.5 | −99.0000 |
| S12 | Aspherical | 5.4822 | 0.9068 | | | 1.2361 |
| S13 | Aspherical | −2.8323 | 0.2003 | 1.55 | 64.1 | 0.8889 |
| S14 | Aspherical | −11.9927 | 0.2011 | | | 30.8287 |
| S15 | Aspherical | 2.6017 | 0.4102 | 1.55 | 64.1 | −44.5197 |
| S16 | Aspherical | 2.3997 | 1.0298 | | | −32.9699 |
| S17 | Spherical | Infinite | 0.2100 | 1.52 | 64.1 | |
| S18 | Spherical | Infinite | 0.2017 | | | |
| S19 | Spherical | Infinite | | | | |

TABLE 20

| Surface | | | | | | | | |
|---|---|---|---|---|---|---|---|---|
| number | A4 | A6 | A8 | A10 | A12 | A14 | A16 | A18 |
| S1 | −4.8557E−04 | −6.8188E−05 | −1.0392E−03 | 8.8555E−04 | −5.3393E−04 | 1.8797E−04 | −3.4613E−05 | 2.6629E−06 |
| S2 | 1.6769E−02 | −2.0830E−02 | 1.3804E−02 | −6.8033E−03 | 2.6189E−03 | −7.0298E−04 | 1.1001E−04 | −7.2440E−06 |
| S3 | 4.4665E−02 | −1.0069E−01 | 1.1991E−01 | −9.7447E−02 | 5.5291E−02 | −2.0374E−02 | 4.2538E−03 | −3.7638E−04 |
| S4 | −3.7241E−02 | 1.2142E−01 | −1.5469E−01 | 6.9235E−02 | 2.1800E−02 | −3.3038E−02 | 1.1581E−02 | −1.3583E−03 |
| S5 | −7.6835E−02 | 2.5220E−01 | −3.1323E−01 | 1.8267E−01 | −9.1081E−02 | 7.1627E−02 | −3.8132E−02 | 7.5638E−03 |
| S6 | 7.0672E−02 | −3.6796E−01 | 1.0456E+00 | −1.7682E+00 | 1.7159E+00 | −9.4762E−01 | 2.7732E−01 | −3.3293E−02 |
| S7 | 7.2821E−02 | −4.6405E−01 | 1.3000E+00 | −2.1071E+00 | 2.0365E+00 | −1.1397E+00 | 3.3409E−01 | −3.8314E−02 |
| S8 | −3.6930E−03 | −1.3734E−01 | 4.8071E−01 | −7.7336E−01 | 7.0897E−01 | −3.5434E−01 | 7.6183E−02 | −1.0245E−03 |
| S9 | 4.5172E−03 | −2.4425E−02 | 3.7752E−02 | −5.4189E−02 | 5.4481E−02 | −3.5215E−02 | 1.2972E−02 | −1.9673E−03 |
| S10 | 2.4676E−03 | −3.8224E−02 | 4.4477E−02 | −3.7165E−02 | 1.8941E−02 | −4.9633E−03 | 2.6460E−04 | 1.1296E−04 |
| S11 | 3.1774E−02 | −1.0769E−01 | 1.2443E−01 | −8.9971E−02 | 3.8624E−02 | −8.2951E−03 | 4.4746E−04 | 6.9803E−05 |
| S12 | 2.8263E−02 | −8.7237E−02 | 9.3833E−02 | −5.2863E−02 | 1.2388E−02 | 1.7302E−03 | −1.4297E−03 | 1.9689E−04 |
| S13 | 1.5845E−01 | −3.3553E−01 | 3.7706E−01 | −2.8518E−01 | 1.5673E−01 | −5.9427E−02 | 1.3298E−02 | −1.2822E−03 |
| S14 | 7.1070E−02 | −1.3881E−01 | 1.0016E−01 | −3.0958E−02 | 1.5512E−03 | 1.4438E−03 | −3.4473E−04 | 2.4198E−05 |
| S15 | −1.6933E−02 | −1.3772E−02 | 7.3938E−03 | −2.2889E−04 | −5.4409E−04 | 1.3358E−04 | −1.1729E−05 | 2.9818E−07 |
| S16 | 4.0387E−03 | −3.2026E−02 | 2.2578E−02 | −9.5370E−03 | 2.5579E−03 | −4.1950E−04 | 3.8034E−05 | −1.4571E−06 |

TABLE 21

| | | | |
|---|---|---|---|
| ImgH (mm) | 3.40 | f3 (mm) | 11.82 |
| TTL (mm) | 7.49 | f4 (mm) | −4.92 |
| HFOV (°) | 24.8 | f5 (mm) | 5.42 |
| f (mm) | 7.00 | f6 (mm) | −18.80 |
| f1 (mm) | 4.31 | f7 (mm) | −6.85 |
| f2 (mm) | −12.00 | f8 (mm) | −200.00 |

FIG. 14A shows a longitudinal aberration curve of the optical imaging lens group according to embodiment 7 to represent deviations of a convergence focal point after light with different wavelengths passes through the lens. FIG. 14B shows an astigmatism curve of the optical imaging lens group according to embodiment 7 to represent a tangential image surface curvature and a sagittal image surface curvature. FIG. 14C shows a distortion curve of the optical imaging lens group according to embodiment 7 to represent distortion values corresponding to different image heights. FIG. 14D shows a lateral color curve of the optical imaging lens group according to embodiment 7 to represent deviations of different image heights on the imaging surface after the light passes through the lens. According to FIG. 14A to FIG. 14D, it can be seen that the optical imaging lens group provided in embodiment 7 may achieve high imaging quality.

### Embodiment 8

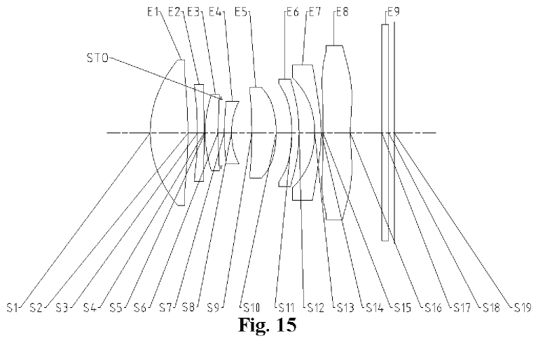

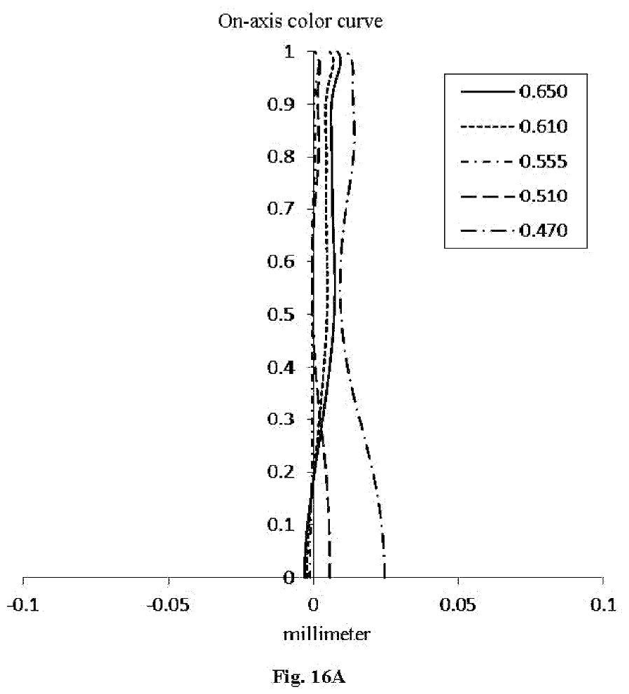

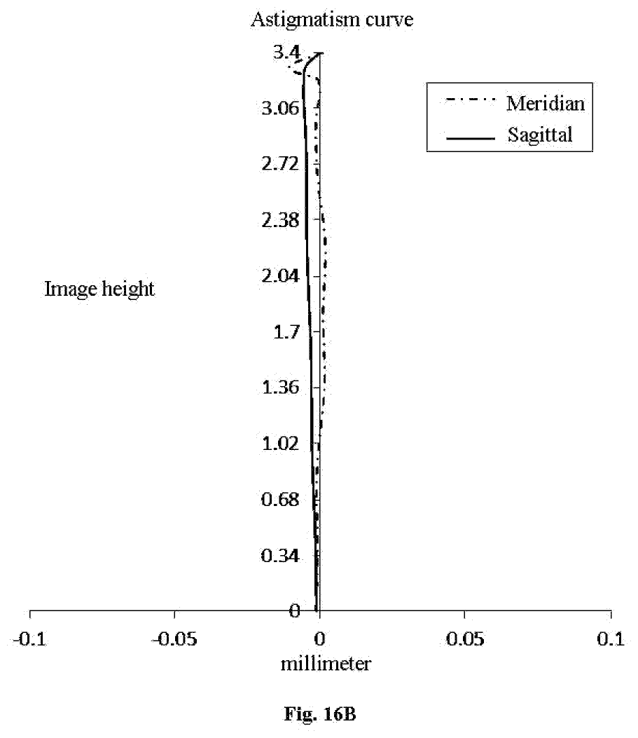

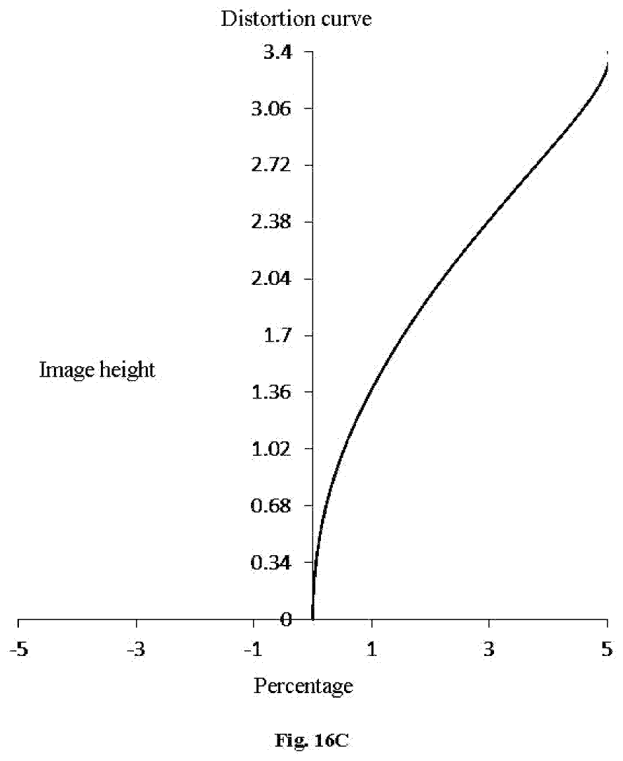

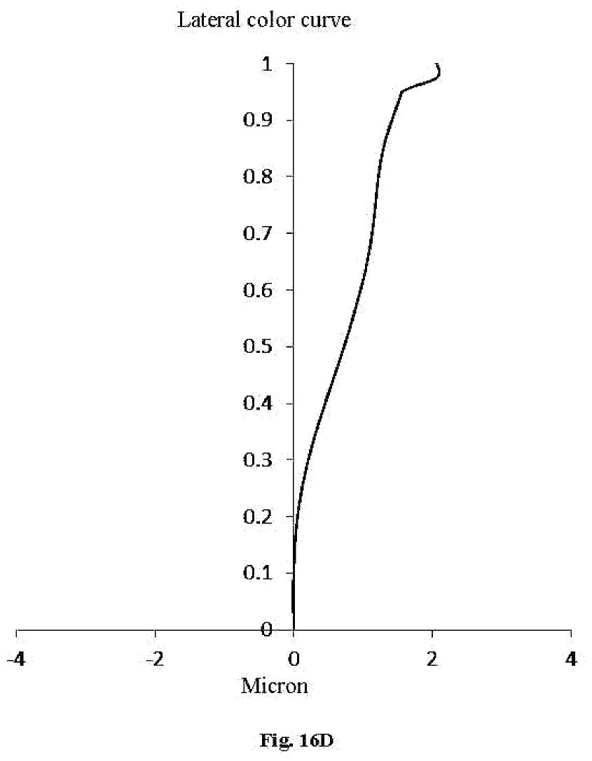

An optical imaging lens group according to embodiment 8 of the disclosure will be described below with reference to FIG. 15 to FIG. 16D. FIG. 15 is a structure diagram of an optical imaging lens group according to embodiment 8 of the disclosure.

As shown in FIG. 15, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has positive refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a concave surface, and an image-side surface S10 is a convex surface. The sixth lens E6 has negative refractive power, an object-side surface S11 thereof is a concave surface, and an image-side surface S12 is a convex surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 22 shows a surface type, curvature radius, thickness, material and cone coefficient of each lens of the optical imaging lens group according to embodiment 8. Units of the curvature radius and the thickness are millimeter (mm). Table 23 shows high-order coefficients applied to each aspherical mirror surface in embodiment 8. A surface type of each aspherical surface may be defined by formula (1) given in embodiment 1. Table 24 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 8.

TABLE 22

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 3.1223 | 1.1655 | 1.55 | 64.1 | −0.2573 |
| S2 | Aspherical | −9.5972 | 0.2928 | | | −98.1456 |
| S3 | Aspherical | −7.1571 | 0.2000 | 1.65 | 23.5 | −56.2777 |
| S4 | Aspherical | −200.0000 | 0.0300 | | | 97.9819 |
| S5 | Aspherical | 3.4032 | 0.3964 | 1.55 | 64.1 | −0.0435 |
| S6 | Aspherical | 11.4331 | 0.0976 | | | 9.5575 |
| STO | Spherical | Infinite | 0.0958 | | | |
| S7 | Aspherical | 6.5076 | 0.2197 | 1.66 | 21.5 | −61.4767 |
| S8 | Aspherical | 2.0934 | 0.6272 | | | −0.2636 |
| S9 | Aspherical | −21.2397 | 0.7527 | 1.65 | 23.5 | 81.7787 |
| S10 | Aspherical | −3.0731 | 0.4845 | | | 2.2195 |
| S11 | Aspherical | −3.4054 | 0.2147 | 1.66 | 21.5 | 1.1450 |
| S12 | Aspherical | −5.1227 | 0.4789 | | | 1.0399 |
| S13 | Aspherical | −2.6869 | 0.2069 | 1.55 | 64.1 | 0.6767 |
| S14 | Aspherical | −3.3753 | 0.0494 | | | −24.2627 |
| S15 | Aspherical | 126.0219 | 0.8356 | 1.55 | 64.1 | −99.0000 |
| S16 | Aspherical | 4.5694 | 0.9743 | | | −46.3209 |
| S17 | Spherical | Infinite | 0.2100 | 1.52 | 64.1 | |
| S18 | Spherical | Infinite | 0.1680 | | | |
| S19 | Spherical | Infinite | | | | |

TABLE 23

| Surface | | | | | | | | |
|---|---|---|---|---|---|---|---|---|
| number | A4 | A6 | A8 | A10 | A12 | A14 | A16 | A18 |
| S1 | −7.3159E−04 | −1.2432E−04 | −1.4282E−04 | −2.2838E−05 | 4.2496E−05 | −2.0457E−05 | 4.9947E−06 | −4.4327E−07 |
| S2 | 1.2999E−02 | −1.6963E−02 | 1.0716E−02 | −4.4165E−03 | 1.2801E−03 | −2.4139E−04 | 2.5680E−05 | −1.1623E−06 |
| S3 | 4.4033E−02 | −1.0513E−01 | 1.3294E−01 | −1.0665E−01 | 5.5314E−02 | −1.7890E−02 | 3.2576E−03 | −2.5293E−04 |
| S4 | −4.8106E−03 | −2.2261E−02 | 8.6590E−02 | −1.2168E−01 | 8.8841E−02 | −3.6248E−02 | 7.8407E−03 | −6.9273E−04 |
| S5 | −3.0239E−02 | 5.7601E−02 | −1.9342E−02 | −3.6234E−02 | 2.9953E−02 | −7.1030E−03 | −4.7929E−05 | 2.0179E−04 |
| S6 | 4.4715E−02 | −1.1405E−01 | 1.1837E−01 | −5.7765E−02 | −4.5455E−02 | 8.0258E−02 | −4.0446E−02 | 7.0325E−03 |
| S7 | 4.3241E−02 | −1.6821E−01 | 2.4181E−01 | −1.3136E−01 | −1.2914E−01 | 2.8940E−01 | −2.0343E−01 | 5.2338E−02 |
| S8 | 5.3786E−03 | −8.8971E−02 | 2.0109E−01 | −1.5157E−01 | −7.3814E−02 | 2.7815E−01 | −2.3720E−01 | 7.1099E−02 |
| S9 | −5.3613E−03 | −1.3949E−02 | 2.8371E−02 | −7.2700E−02 | 1.1206E−01 | −9.7405E−02 | 4.4828E−02 | −8.1608E−03 |
| S10 | −1.1300E−03 | −2.0193E−03 | −2.5356E−02 | 3.6767E−02 | −3.4354E−02 | 2.1107E−02 | −7.6221E−03 | 1.2424E−03 |
| S11 | −1.7809E−03 | 6.1103E−02 | −1.0114E−01 | 6.1033E−02 | −9.5162E−03 | −8.6890E−03 | 5.0254E−03 | −7.9116E−04 |
| S12 | −3.0220E−02 | 8.3353E−02 | −9.3334E−02 | 5.1388E−02 | −1.2143E−02 | −6.7566E−04 | 8.4945E−04 | −1.0572E−04 |
| S13 | 1.6451E−02 | −2.6675E−02 | 1.2393E−02 | −8.3750E−03 | 6.8738E−03 | −1.7750E−03 | −2.6581E−04 | 1.1407E−04 |
| S14 | 3.5340E−02 | −3.6123E−02 | 3.7371E−03 | 1.1739E−02 | −7.1138E−03 | 1.8086E−03 | −2.2123E−04 | 1.0709E−05 |
| S15 | −1.5996E−02 | −7.0006E−03 | 1.0961E−02 | −4.3933E−03 | 9.1255E−04 | −1.0757E−04 | 6.8239E−06 | −1.8074E−07 |
| S16 | −3.8101E−02 | 1.1169E−02 | −3.3004E−03 | 9.0179E−04 | −1.9701E−04 | 2.9642E−05 | −2.5263E−06 | 8.9041E−08 |

TABLE 24

| | | | |
|---|---|---|---|
| ImgH (mm) | 3.40 | f3 (mm) | 8.72 |
| TTL (mm) | 7.50 | f4 (mm) | −4.80 |
| HFOV (°) | 24.8 | f5 (mm) | 5.49 |
| f (mm) | 7.00 | f6 (mm) | −16.28 |
| f1 (mm) | 4.46 | f7 (mm) | −27.00 |
| f2 (mm) | −11.52 | f8 (mm) | −8.71 |

FIG. 16A shows a longitudinal aberration curve of the optical imaging lens group according to embodiment 8 to represent deviations of a convergence focal point after light with different wavelengths passes through the lens. FIG. 16B shows an astigmatism curve of the optical imaging lens group according to embodiment 8 to represent a tangential image surface curvature and a sagittal image surface curvature. FIG. 16C shows a distortion curve of the optical imaging lens group according to embodiment 8 to represent distortion values corresponding to different image heights. FIG. 16D shows a lateral color curve of the optical imaging lens group according to embodiment 8 to represent deviations of different image heights on the imaging surface after the light passes through the lens. According to FIG. 16A to FIG. 16D, it can be seen that the optical imaging lens group provided in embodiment 8 may achieve high imaging quality.

### Embodiment 9

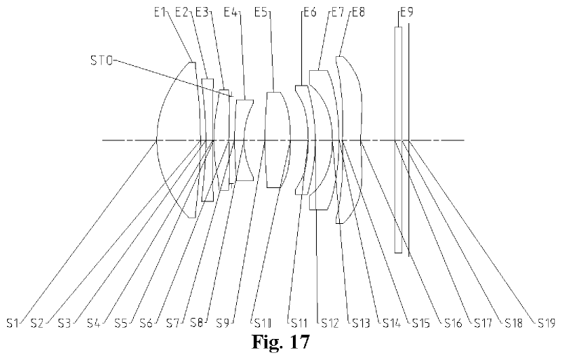

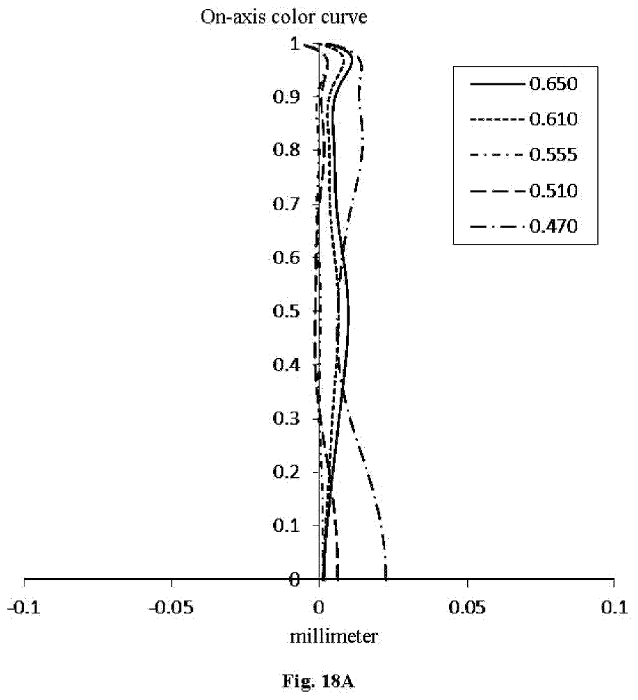

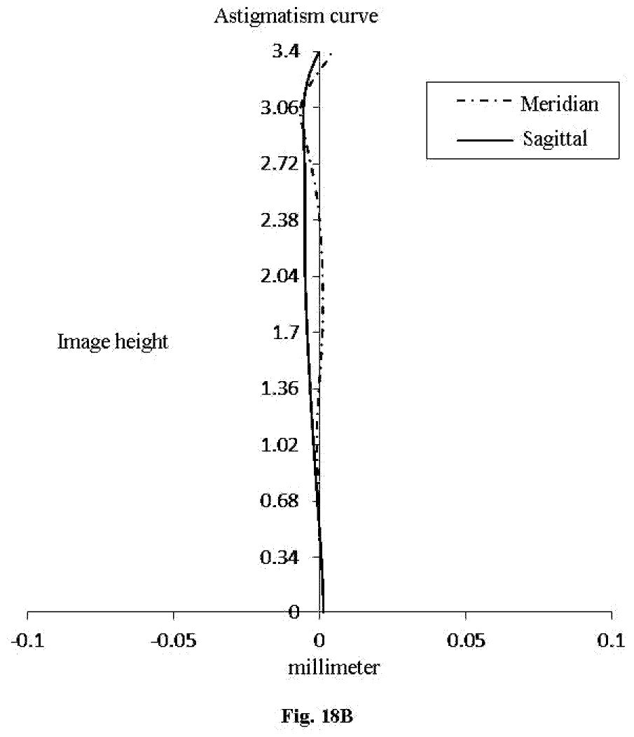

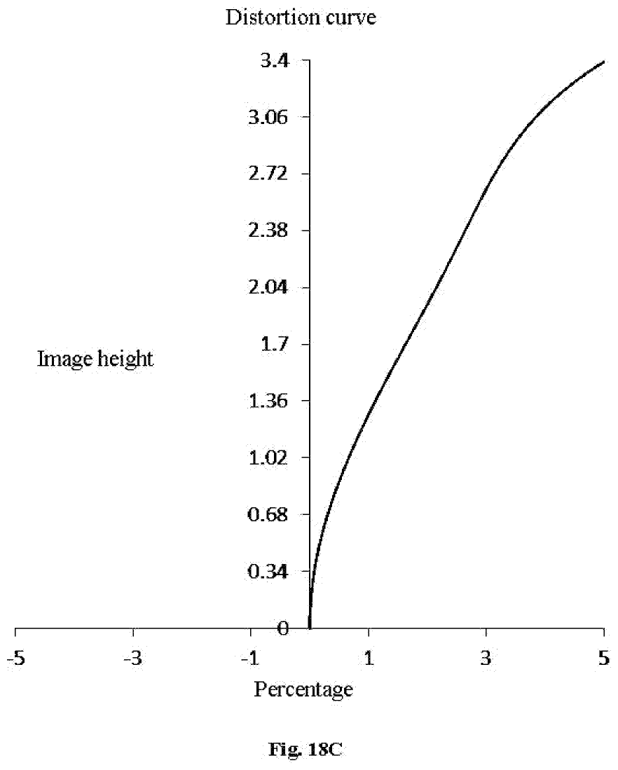

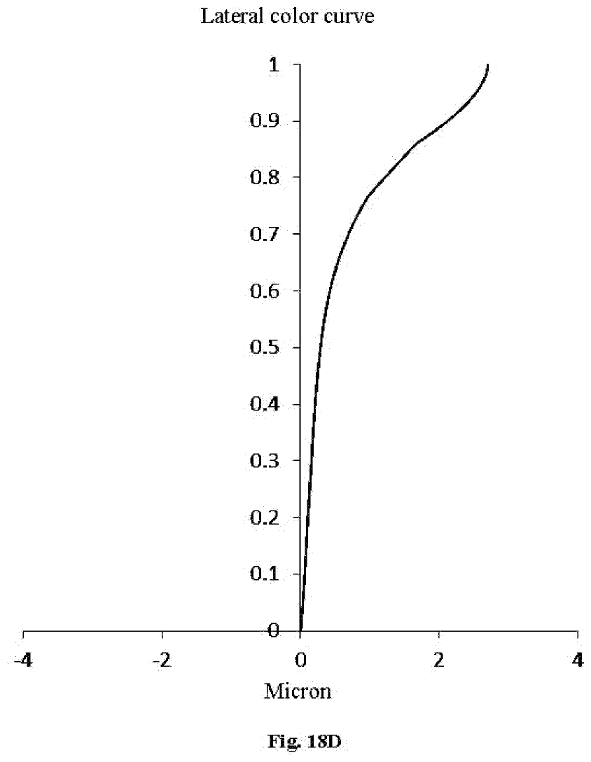

An optical imaging lens group according to embodiment 9 of the disclosure will be described below with reference to FIG. 17 to FIG. 18D. FIG. 17 is a structure diagram of an optical imaging lens group according to embodiment 9 of the disclosure.

As shown in FIG. 17, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a concave surface. The third lens E3 has positive refractive power, an object-side surface S5 thereof is a convex surface, and an image-side surface S6 is a concave surface. The fourth lens E4 has negative refractive power, an object-side surface S7 thereof is a convex surface, and an image-side surface S8 is a concave surface. The fifth lens E5 has positive refractive power, an object-side surface S9 thereof is a convex surface, and an image-side surface S10 is a convex surface. The sixth lens E6 has negative refractive power, an object-side surface S11 thereof is a concave surface, and an image-side surface S12 is a convex surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 25 shows a surface type, curvature radius, thickness, material and cone coefficient of each lens of the optical imaging lens group according to embodiment 9. Units of the curvature radius and the thickness are millimeter (mm). Table 26 shows high-order coefficients applied to each aspherical mirror surface in embodiment 9. A surface type of each aspherical surface may be defined by formula (1) given in embodiment 1. Table 27 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 9.

TABLE 25

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 2.9493 | 1.2889 | 1.55 | 64.1 | −0.2827 |
| S2 | Aspherical | −9.9921 | 0.1569 | | | −98.6489 |
| S3 | Aspherical | −7.8185 | 0.2000 | 1.65 | 23.5 | −62.5467 |
| S4 | Aspherical | 730.8709 | 0.0300 | | | 97.9819 |
| S5 | Aspherical | 4.5888 | 0.4427 | 1.55 | 64.1 | −0.0431 |
| S6 | Aspherical | 17.9515 | 0.0858 | | | 68.9737 |
| STO | Spherical | Infinite | 0.0753 | | | |
| S7 | Aspherical | 6.6792 | 0.2838 | 1.66 | 21.5 | −59.2954 |
| S8 | Aspherical | 2.1078 | 0.6134 | | | −0.8832 |
| S9 | Aspherical | 11.6284 | 0.7538 | 1.65 | 23.5 | −16.3183 |
| S10 | Aspherical | −5.5673 | 0.5204 | | | 7.2065 |
| S11 | Aspherical | −4.1453 | 0.2068 | 1.66 | 21.5 | 3.6122 |
| S12 | Aspherical | −5.1996 | 0.5029 | | | 1.2361 |
| S13 | Aspherical | −3.0180 | 0.2003 | 1.55 | 64.1 | 1.3566 |
| S14 | Aspherical | −5.5501 | 0.0905 | | | −16.8099 |
| S15 | Aspherical | 12.5411 | 0.5322 | 1.55 | 64.1 | −96.7204 |
| S16 | Aspherical | 4.2962 | 1.0063 | | | −32.9699 |
| S17 | Spherical | Infinite | 0.2100 | 1.52 | 64.1 | |
| S18 | Spherical | Infinite | 0.2001 | | | |
| S19 | Spherical | Infinite | | | | |

TABLE 26

| Surface | | | | | | | | |
|---|---|---|---|---|---|---|---|---|
| number | A4 | A6 | A8 | A10 | A12 | A14 | A16 | A18 |
| S1 | −5.7105E−04 | −2.7545E−04 | 2.1130E−04 | −2.2357E−04 | 1.0797E−04 | −2.9197E−05 | 4.0803E−06 | −2.1832E−07 |
| S2 | 2.1059E−02 | −3.0921E−02 | 2.0605E−02 | −8.4405E−03 | 2.2535E−03 | −3.8076E−04 | 3.6904E−05 | −1.5608E−06 |
| S3 | 4.1069E−02 | −8.3235E−02 | 8.1179E−02 | −4.8317E−02 | 1.8329E−02 | −4.2908E−03 | 5.6220E−04 | −3.1441E−05 |
| S4 | −1.8949E−03 | −1.3781E−02 | 3.6789E−02 | −3.7350E−02 | 1.9648E−02 | −5.5708E−03 | 7.9019E−04 | −4.1186E−05 |
| S5 | −2.2606E−02 | 3.1190E−02 | −1.1746E−02 | −1.1143E−02 | 6.8941E−03 | −2.7579E−05 | −6.7386E−04 | 1.1940E−04 |
| S6 | 3.3248E−02 | −8.6289E−02 | 1.0711E−01 | −1.0650E−01 | 6.5782E−02 | −2.2989E−02 | 4.1029E−03 | −2.7893E−04 |
| S7 | 8.8380E−03 | −6.6303E−02 | 1.2063E−01 | −1.2914E−01 | 8.2805E−02 | −2.6710E−02 | 1.9952E−03 | 6.0083E−04 |
| S8 | −2.8358E−02 | −1.3793E−03 | 8.3692E−02 | −1.5408E−01 | 1.7742E−01 | −1.2802E−01 | 5.2934E−02 | −9.5663E−03 |
| S9 | −1.6781E−03 | −7.4638E−03 | 1.7937E−02 | −3.5836E−02 | 4.2779E−02 | −2.9236E−02 | 1.0662E−02 | −1.5430E−03 |
| S10 | −1.2016E−02 | −3.2251E−03 | −1.9529E−02 | 3.1633E−02 | −3.0292E−02 | 1.8003E−02 | −5.9950E−03 | 8.7177E−04 |
| S11 | 1.0615E−02 | −2.8446E−03 | −4.0803E−02 | 3.2365E−02 | −7.6477E−03 | −1.9187E−03 | 1.5519E−03 | −2.6182E−04 |
| S12 | 1.0214E−02 | 1.5829E−02 | −4.4828E−02 | 3.3391E−02 | −8.4441E−03 | −1.0569E−03 | 9.1116E−04 | −1.2522E−04 |
| S13 | −3.8275E−03 | −6.4193E−03 | −1.7195E−02 | 1.9956E−02 | −6.5057E−03 | 1.9141E−04 | 1.6939E−04 | −1.0737E−05 |
| S14 | 2.2569E−02 | −1.6133E−02 | −1.1012E−02 | 1.6552E−02 | −7.9346E−03 | 1.9008E−03 | −2.3196E−04 | 1.1547E−05 |
| S15 | −5.8631E−02 | 4.5247E−02 | −2.7573E−02 | 1.1102E−02 | −2.7814E−03 | 4.1958E−04 | −3.5129E−05 | 1.2555E−06 |
| S16 | −5.6851E−02 | 2.2728E−02 | −8.4971E−03 | 2.1863E−03 | −3.9056E−04 | 4.5704E−05 | −2.9520E−06 | 6.7614E−08 |

TABLE 27

| | | | |
|---|---|---|---|
| ImgH (mm) | 3.40 | f3 (mm) | 11.16 |
| TTL (mm) | 7.40 | f4 (mm) | −4.81 |
| HFOV (°) | 24.8 | f5 (mm) | 5.94 |
| f (mm) | 7.00 | f6 (mm) | −33.77 |
| f1 (mm) | 4.32 | f7 (mm) | −12.47 |
| f2 (mm) | −12.00 | f8 (mm) | −12.25 |

FIG. 18A shows a longitudinal aberration curve of the optical imaging lens group according to embodiment 9 to represent deviations of a convergence focal point after light with different wavelengths passes through the lens. FIG. 18B shows an astigmatism curve of the optical imaging lens group according to embodiment 9 to represent a tangential image surface curvature and a sagittal image surface curvature. FIG. 18C shows a distortion curve of the optical imaging lens group according to embodiment 9 to represent distortion values corresponding to different image heights. FIG. 18D shows a lateral color curve of the optical imaging lens group according to embodiment 9 to represent deviations of different image heights on the imaging surface after the light passes through the lens. According to FIG. 18A to FIG. 18D, it can be seen that the optical imaging lens group provided in embodiment 9 may achieve high imaging quality.

### Embodiment 10

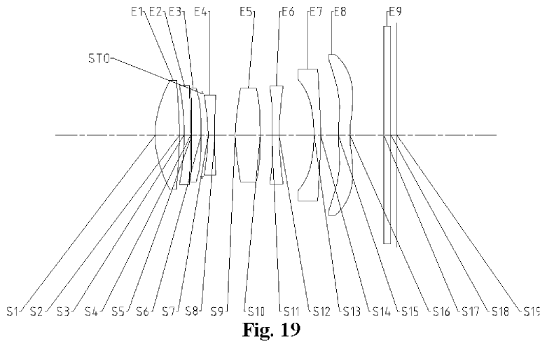

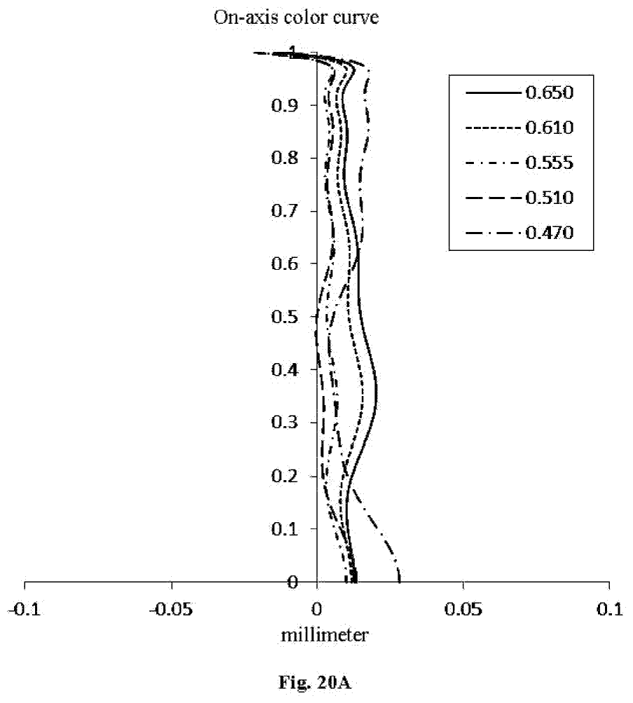

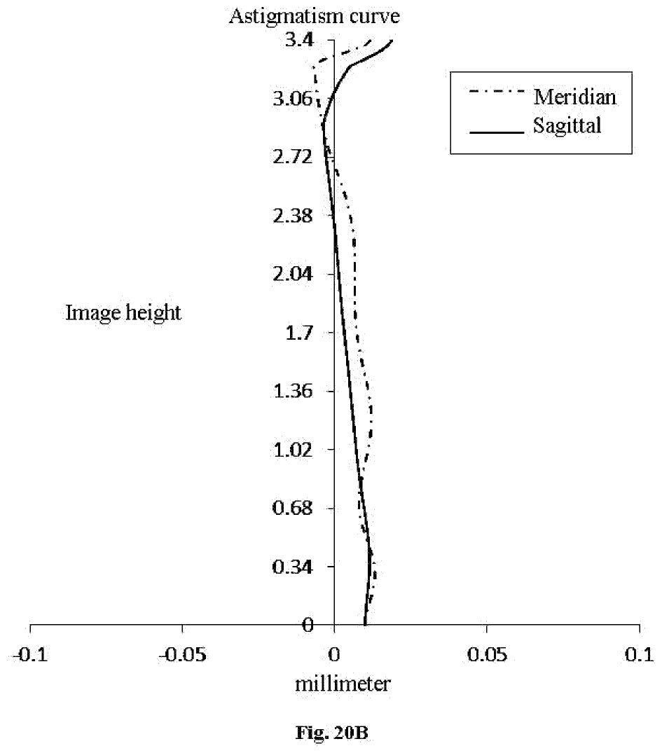

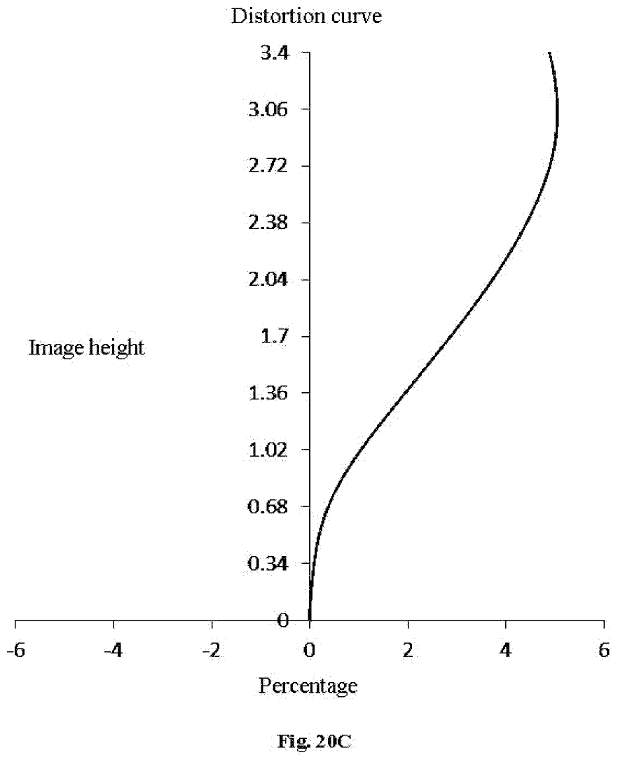

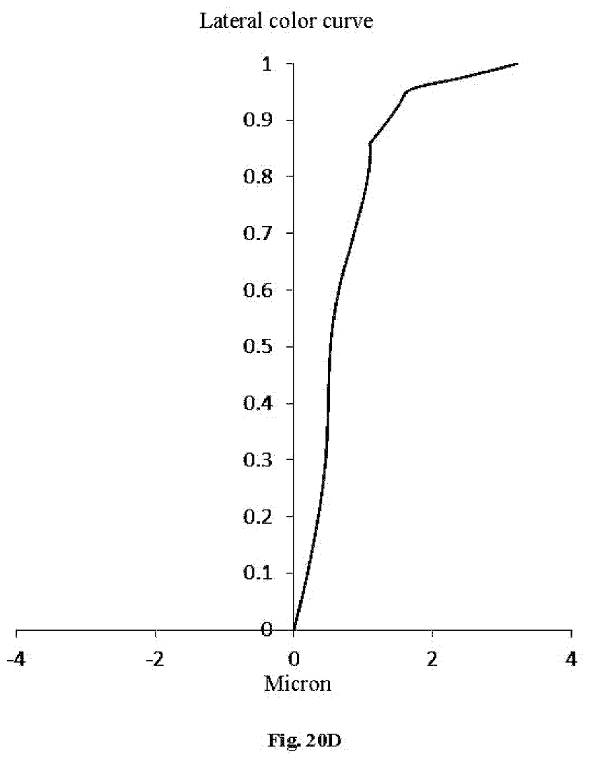

An optical imaging lens group according to embodiment 10 of the disclosure will be described below with reference to FIG. 19 to FIG. 20D. FIG. 19 is a structure diagram of an optical imaging lens group according to embodiment 10 of the disclosure.

As shown in FIG. 19, the optical imaging lens group according to an exemplary implementation mode of the disclosure sequentially includes, from an object side to an image side along an optical axis, a first lens E1, a second lens E2, a third lens E3, a diaphragm STO, a fourth lens E4, a fifth lens E5, a sixth lens E6, a seventh lens E7, an eighth lens E8, an optical filter E9 and an imaging surface S19.

The first lens E1 has positive refractive power, an object-side surface S1 thereof is a convex surface, and an image-side surface S2 is a convex surface. The second lens E2 has negative refractive power, an object-side surface S3 thereof is a concave surface, and an image-side surface S4 is a convex surface. The third lens E3 has positive refractive power, an object-side surface S5 thereof is a concave surface, and an image-side surface S6 is a convex surface. The fourth lens E4 has negative refractive power, an object-side surface S7 thereof is a concave surface, and an image-side surface S8 is a convex surface. The fifth lens E5 has positive refractive power, an object-side surface S9 thereof is a convex surface, and an image-side surface S10 is a convex surface. The sixth lens E6 has negative refractive power, an object-side surface S11 thereof is a convex surface, and an image-side surface S12 is a concave surface. The seventh lens E7 has negative refractive power, an object-side surface S13 thereof is a concave surface, and an image-side surface S14 is a convex surface. The eighth lens E8 has negative refractive power, an object-side surface S15 thereof is a convex surface, and an image-side surface S16 is a concave surface. The optical filter E9 has an object-side surface S17 and an image-side surface S18. Light from an object sequentially penetrates through each of the surfaces S1 to S18 and is finally imaged on the imaging surface S19.

Table 28 shows a surface type, curvature radius, thickness, material and cone coefficient of each lens of the optical imaging lens group according to embodiment 10. Units of the curvature radius and the thickness are millimeter (mm). Table 29 shows high-order coefficients applied to each aspherical mirror surface in embodiment 10. A surface type of each aspherical surface may be defined by formula (1) given in embodiment 1. Table 30 shows a ImgH (ImgH is a half of a diagonal length of an effective pixel region on the imaging surface S19), a distance TTL from the object-side surface S1 of the first lens E1 to the imaging surface S19 on the optical axis, a maximum half-field of view (HFOV), a total effective focal length f of the optical imaging lens group and effective focal lengths f1 to f8 of each lens in embodiment 10.

TABLE 28

| | | | | Material | | |
|---|---|---|---|---|---|---|
| | | | | Refrac- | | |
| Surface | Surface | Curvature | Thick- | tive | Abbe | Conic |
| number | type | radius | ness | index | number | coefficient |
| OBJ | Spherical | Infinite | Infinite | | | |
| S1 | Aspherical | 3.0125 | 0.7401 | 1.55 | 64.1 | −0.2827 |
| S2 | Aspherical | −8.5695 | 0.1374 | | | −98.6489 |
| S3 | Aspherical | −6.7175 | 0.2000 | 1.65 | 23.5 | −31.6312 |
| S4 | Aspherical | −18.8415 | 0.0300 | | | 97.9819 |
| S5 | Aspherical | −250.3086 | 0.2834 | 1.55 | 64.1 | −0.0431 |
| S6 | Aspherical | −10.9800 | 0.0300 | | | 11.7170 |
| STO | Spherical | Infinite | 0.1845 | | | |
| S7 | Aspherical | −3.2752 | 0.2000 | 1.66 | 21.5 | −59.2954 |
| S8 | Aspherical | −78.2034 | 0.6134 | | | −99.0000 |
| S9 | Aspherical | 3.7213 | 0.7538 | 1.65 | 23.5 | −16.3183 |
| S10 | Aspherical | −18.9197 | 0.3454 | | | 64.3310 |
| S11 | Aspherical | 40.1533 | 0.2205 | 1.66 | 21.5 | −99.0000 |
| S12 | Aspherical | 6.7181 | 1.0575 | | | 1.2361 |
| S13 | Aspherical | −4.1066 | 0.2003 | 1.55 | 64.1 | 2.2675 |
| S14 | Aspherical | −10.0511 | 0.5329 | | | −45.4835 |
| S15 | Aspherical | 3.9540 | 0.3467 | 1.55 | 64.1 | −99.0000 |
| S16 | Aspherical | 2.5290 | 1.0210 | | | −32.9699 |
| S17 | Spherical | Infinite | 0.2100 | 1.52 | 64.1 | |
| S18 | Spherical | Infinite | 0.1929 | | | |
| S19 | Spherical | Infinite | | | | |

TABLE 29

| Surface | | | | | | | | |
|---|---|---|---|---|---|---|---|---|
| number | A4 | A6 | A8 | A10 | A12 | A14 | A16 | A18 |
| S1 | −7.9002E−04 | −3.4230E−03 | 4.4720E−07 | 2.0522E−03 | −1.5049E−03 | 3.9723E−04 | −2.1433E−05 | −3.9170E−06 |
| S2 | 3.7741E−02 | −1.3104E−01 | 1.9369E−01 | −1.5896E−01 | 7.8551E−02 | −2.3404E−02 | 3.9187E−03 | −2.8792E−04 |
| S3 | 7.6615E−02 | −2.7039E−01 | 4.4365E−01 | −4.1992E−01 | 2.4107E−01 | −8.3053E−02 | 1.5824E−02 | −1.2895E−03 |
| S4 | −7.5922E−03 | 2.3928E−02 | −9.6804E−03 | −1.1866E−02 | 5.9781E−03 | 6.2648E−03 | −5.0863E−03 | 9.8835E−04 |
| S5 | −4.2146E−02 | 1.4160E−01 | −2.1697E−01 | 1.8062E−01 | −1.0301E−01 | 4.4571E−02 | −1.3217E−02 | 1.8547E−03 |
| S6 | 8.6493E−02 | −2.7247E−01 | 4.5547E−01 | −5.1184E−01 | 3.6449E−01 | −1.5684E−01 | 3.7059E−02 | −3.6564E−03 |
| S7 | −1.5452E−02 | −1.3889E−01 | 4.0151E−01 | −5.2928E−01 | 4.0917E−01 | −1.8416E−01 | 4.3771E−02 | −4.0827E−03 |
| S8 | 7.8943E−02 | −3.6313E−01 | 8.9614E−01 | −1.3289E+00 | 1.2653E+00 | −7.4742E−01 | 2.4869E−01 | −3.5573E−02 |
| S9 | −1.7739E−03 | −3.3681E−02 | 4.0106E−02 | −2.8538E−02 | 1.3585E−02 | −3.0268E−03 | −1.3384E−04 | 1.3193E−04 |
| S10 | 6.1770E−03 | −5.4673E−02 | 5.9374E−02 | −4.0524E−02 | 1.8620E−02 | −4.8147E−03 | 3.5371E−04 | 6.4797E−05 |
| S11 | 4.9918E−02 | −1.6175E−01 | 1.9859E−01 | −1.6946E−01 | 1.0479E−01 | −4.3853E−02 | 1.0758E−02 | −1.1455E−03 |
| S12 | 4.0452E−02 | −1.3405E−01 | 1.6811E−01 | −1.4269E−01 | 8.6729E−02 | −3.5313E−02 | 8.4474E−03 | −8.7689E−04 |
| S13 | 7.7055E−02 | −1.4340E−01 | 1.3479E−01 | −9.6478E−02 | 5.2857E−02 | −1.9535E−02 | 4.0942E−03 | −3.5769E−04 |
| S14 | 5.8288E−02 | −7.3996E−02 | 3.7639E−02 | −4.9590E−03 | −2.7143E−03 | 1.2464E−03 | −1.9866E−04 | 1.1505E−05 |
| S15 | −4.7280E−02 | 1.0980E−02 | −8.2404E−03 | 5.2114E−03 | −1.5697E−03 | 2.4105E−04 | −1.8236E−05 | 5.2730E−07 |
| S16 | −1.6010E−02 | −1.6373E−02 | 1.0794E−02 | −3.9132E−03 | 9.0793E−04 | −1.3138E−04 | 1.0596E−05 | −3.6229E−07 |

TABLE 30

| | | | |
|---|---|---|---|
| ImgH (mm) | 3.40 | f3 (mm) | 21.03 |
| TTL (mm) | 7.30 | f4 (mm) | −5.21 |
| HFOV (°) | 24.8 | f5 (mm) | 4.89 |
| f (mm) | 7.02 | f6 (mm) | −12.32 |
| f1 (mm) | 4.18 | f7 (mm) | −12.87 |
| f2 (mm) | −16.30 | f8 (mm) | −14.06 |

FIG. 20A shows a longitudinal aberration curve of the optical imaging lens group according to embodiment 10 to represent deviations of a convergence focal point after light with different wavelengths passes through the lens. FIG. 20B shows an astigmatism curve of the optical imaging lens group according to embodiment 10 to represent a tangential image surface curvature and a sagittal image surface curvature. FIG. 20C shows a distortion curve of the optical imaging lens group according to embodiment 10 to represent distortion values corresponding to different image heights. FIG. 20D shows a lateral color curve of the optical imaging lens group according to embodiment 10 to represent deviations of different image heights on the imaging surface after the light passes through the lens. According to FIG. 20A to FIG. 20D, it can be seen that the optical imaging lens group provided in embodiment 10 may achieve high imaging quality.

From the above, embodiment 1 to embodiment 10 meet a relationship shown in Table 31 respectively.

TABLE 31

| Conditional expression/ | | | | | | | | | | |
|---|---|---|---|---|---|---|---|---|---|---|
| embodiment | 1 | 2 | 3 | 4 | 5 | 6 | 7 | 8 | 9 | 10 |
| HFOV (°) | 25.2 | 24.4 | 24.9 | 23.4 | 23.3 | 24.6 | 24.8 | 24.8 | 24.8 | 24.8 |
| DT11/DT41 | 1.53 | 2.03 | 1.75 | 1.71 | 1.22 | 1.77 | 1.93 | 2.33 | 1.92 | 1.36 |
| \|SAG42/SAG71\| | 0.49 | 0.25 | 0.40 | 0.55 | 0.61 | 0.46 | 0.41 | 0.32 | 0.40 | 0.05 |
| f1/f | 1.14 | 0.72 | 0.76 | 0.58 | 0.41 | 0.82 | 0.62 | 0.64 | 0.62 | 0.59 |
| f4/f5 | −0.73 | −0.79 | −0.38 | −0.79 | −1.47 | −0.69 | −0.91 | −0.87 | −0.81 | −1.07 |
| f67/f123 | −3.00 | −2.59 | −2.73 | −1.38 | −1.02 | −2.94 | −1.12 | −2.48 | −2.10 | −1.36 |
| CT1/(CT2 + CT3) | 0.71 | 1.81 | 1.24 | 1.74 | 2.42 | 1.18 | 1.51 | 1.95 | 2.01 | 1.53 |
| R13/R1 | −0.80 | −0.83 | −0.91 | −1.26 | −2.28 | −1.10 | −0.91 | −0.86 | −1.02 | −1.36 |
| CT5/(CT6 + CT7) | 1.88 | 1.86 | 1.70 | 1.89 | 1.25 | 0.93 | 1.51 | 1.79 | 1.85 | 1.79 |
| ΣAT/TTL | 0.31 | 0.33 | 0.33 | 0.30 | 0.30 | 0.25 | 0.33 | 0.29 | 0.28 | 0.40 |

The disclosure also provides an imaging device, of which an electronic photosensitive element may be a Charge Coupled Device (CCD) or a Complementary Metal Oxide Semiconductor (CMOS). The imaging device may be an independent imaging device such as a digital camera, and may also be an imaging module integrated into a mobile electronic device such as a mobile phone. The imaging device is provided with the abovementioned optical imaging lens group.

The above description is only description about the preferred embodiments of the disclosure and adopted technical principles. Those skilled in the art should know that the scope of disclosure involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An optical imaging lens group, sequentially comprising, from an object side to an image side along an optical axis, a first lens, a second lens, a third lens, a fourth lens, a fifth lens, a sixth lens, a seventh lens and an eighth lens, wherein
the first lens has positive refractive power, and both an object-side surface and an image-side surface thereof are convex surfaces; the second lens has refractive power, and an object-side surface thereof is a concave surface; the third lens has refractive power; the fourth lens has negative refractive power; the fifth lens has positive refractive power; the sixth lens has refractive power; the seventh lens has refractive power, and an object-side surface thereof is a concave surface; and the eighth lens has negative refractive power.

2. The optical imaging lens group as claimed in claim 1, wherein a maximum half-field of view (HFOV) of the optical imaging lens group meets HFOV≤30°.

3. The optical imaging lens group as claimed in claim 1, wherein a total effective focal length f of the optical imaging lens group and an effective focal length f1 of the first lens meet 0.3<f1/f<1.2.

4. The optical imaging lens group as claimed in claim 3, wherein a maximum effective semi-diameter DT11 of the object-side surface of the first lens and a maximum effective semi-diameter DT41 of an object-side surface of the fourth lens meet 1<DT11/DT41<2.5.

5. The optical imaging lens group as claimed in claim 1, wherein a distance SAG42 from an intersection point of an image-side surface of the fourth lens to the optical axis to a vertex of an effective semi-diameter of the image-side surface of the fourth lens and a distance SAG71 from an intersection point of the object-side surface of the seventh lens and the optical axis to a vertex of an effective semi-diameter of the object-side surface of the seventh lens meet |SAG42/SAG71|<0.7.

6. The optical imaging lens group as claimed in claim 1, wherein an effective focal length f4 of the fourth lens and an effective focal length f5 of the fifth lens meet −1.5<f4/f5<−0.3.

7. The optical imaging lens group as claimed in claim 1, wherein a curvature radius R13 of the object-side surface of the seventh lens and a curvature radius R1 of the object-side surface of the first lens meet −2.5<R13/R1<−0.5.

8. The optical imaging lens group as claimed in claim 1, wherein a center thickness CT1 of the first lens on the optical axis, a center thickness CT2 of the second lens on the optical axis and a center thickness CT3 of the third lens on the optical axis meet 0.5<CT1/(CT2+CT3)<2.5.

9. The optical imaging lens group as claimed in claim 1, wherein a center thickness CT5 of the fifth lens on the optical axis, a center thickness CT6 of the sixth lens on the optical axis and a center thickness CT7 of the seventh lens on the optical axis meet 0.9<CT5/(CT6+CT7)<2.

10. The optical imaging lens group as claimed in claim 1, wherein a combined focal length f67 of the sixth lens and the seventh lens and a combined focal length f123 of the first lens, the second lens and the third lens meet −3≤f67/f123<−1.

11. The optical imaging lens group as claimed in claim 1, wherein a sum ΣAT of spacing distances of any two adjacent lenses in the first lens to the eighth lens on the optical axis and a distance TTL from the object-side surface of the first lens to an imaging surface of the optical imaging lens group on the optical axis meet 0.2<ΣAT/TTL<0.5.

12. An optical imaging lens group, sequentially comprising, from an object side to an image side along an optical axis, a first lens, a second lens, a third lens, a fourth lens, a fifth lens, a sixth lens, a seventh lens and an eighth lens, wherein
the first lens has positive refractive power, and both an object-side surface and an image-side surface thereof are convex surfaces; the second lens has refractive power, and an object-side surface thereof is a concave surface; the third lens has refractive power; the fourth lens has negative refractive power; the fifth lens has positive refractive power; the sixth lens has refractive power; the seventh lens has refractive power; the eighth lens has negative refractive power; and
a maximum half-field of view (HFOV) of the optical imaging lens group meets HFOV≤30°.

13. The optical imaging lens group as claimed in claim 12, wherein a total effective focal length f of the optical imaging lens group and an effective focal length f1 of the first lens meet 0.3<f1/f<1.2.

14. The optical imaging lens group as claimed in claim 12, wherein a maximum effective semi-diameter DT11 of the object-side surface of the first lens and a maximum effective semi-diameter DT41 of an object-side surface of the fourth lens meet 1<DT11/DT41<2.5.

15. The optical imaging lens group as claimed in claim 12, wherein a distance SAG42 from an intersection point of an image-side surface of the fourth lens to the optical axis to a vertex of an effective semi-diameter of the image-side surface of the fourth lens and a distance SAG71 from an intersection point of the object-side surface of the seventh lens and the optical axis to a vertex of an effective semi-diameter of the object-side surface of the seventh lens meet |SAG42/SAG71|<0.7.

16. The optical imaging lens group as claimed in claim 12, wherein an effective focal length f4 of the fourth lens and an effective focal length f5 of the fifth lens meet −1.5<f4/f5<−0.3.

17. The optical imaging lens group as claimed in claim 13, wherein an object-side surface of the seventh lens is a concave surface, and a curvature radius R13 of the object-side surface of the seventh lens and a curvature radius R1 of the object-side surface of the first lens meet −2.5<R13/R1<−0.5.

18. The optical imaging lens group as claimed in claim 12, wherein a center thickness CT1 of the first lens on the optical axis, a center thickness CT2 of the second lens on the optical axis and a center thickness CT3 of the third lens on the optical axis meet 0.5<CT1/(CT2+CT3)<2.5.

19. The optical imaging lens group as claimed in claim 12, wherein a center thickness CT5 of the fifth lens on the optical axis, a center thickness CT6 of the sixth lens on the optical axis and a center thickness CT7 of the seventh lens on the optical axis meet 0.9<CT5/(CT6+CT7)<2.

20. The optical imaging lens group as claimed in claim 12, wherein a combined focal length f67 of the sixth lens and the seventh lens and a combined focal length f123 of the first lens, the second lens and the third lens meet −3≤f67/f123<−1.

21. (canceled)
